(19) United States
(12) Patent Application Publication
(10) Pub. No.: US 2026/0064038 A1
(43) Pub. Date: Mar. 5, 2026

(54) DEVELOPING ROLLER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: RYO SUGIYAMA, Shizuoka (JP); KENTA MATSUNAGA, Shizuoka (JP); KANA SATO, Shizuoka (JP); ATSUSHI NOGUCHI, Shizuoka (JP)

(21) Appl. No.: 19/305,005

(22) Filed: Aug. 20, 2025

(30) Foreign Application Priority Data
Aug. 27, 2024 (JP) 2024-145570

(51) Int. Cl. G03G 15/08; G03G 15/02; G03G 21/18

(52) U.S. Cl. CPC G03G 15/0818; G03G 15/0291; G03G 21/1814; G03G 2215/026; G03G 2215/0651

(57) ABSTRACT

A developing roller includes a substrate having a conductive outer surface and a conductive layer on the outer surface of the substrate, an outer surface of the developing roller is formed of at least a first region and a second region having higher conductivity than the first region, the first region and the second region are placed adjacent to each other, the first region is placed on an outer surface of the conductive layer, the outer surface of the developing roller has an impedance of 1.0×10⁶Ω or more, and a potential of the outer surface of the developing roller satisfies a predetermined relationship.

### BACKGROUND

### Field of the Technology

The present disclosure relates to a developing roller, a process cartridge, and an electrophotographic image forming apparatus.

### Description of the Related Art

Due to a recent increase in environmental consciousness, not only improvement in performance of an electrophotographic image forming apparatus (an electrophotographic apparatus) such as high process speed, but also energy saving and resource saving have been required.

Increasing the process speed of the electrophotographic apparatus tends to increase the drive torque when driving the electrophotographic apparatus, resulting in an increase in energy consumption. For this reason, in order to save energy while increasing the process speed, it is required to significantly reduce the drive torque of the electrophotographic apparatus. Further, in order to save resources, there is a need for an electrophotographic member that is not replaced with a process cartridge as in the related art, but can be used for a long period of time while supplying only a toner.

A large proportion of the drive torque of an electrophotographic apparatus is due to a developing apparatus, and among others, the torque generated between a toner supply roller and a developing roller accounts for most of the torque. Therefore, if the drive torque between the toner supply roller and the developing roller can be reduced, it can greatly contribute to an increase in process speed and energy saving. In order to reduce the drive torque, the contact area of the toner supply roller with the developing roller is reduced, or the peripheral speed difference between the developing roller and the toner supply roller is reduced, for example. However, if the contact area of the toner supply roller is reduced or the peripheral speed difference is reduced as described above, the amount of the toner supplied from the toner supply roller to the developing roller is insufficient, and the developing roller cannot transport the toner in some cases.

In order to solve the problems associated with such a reduction in the drive torque, a developing roller having an outer surface formed of an insulating portion and a conductive portion has been studied. When this developing roller is used in an electrophotographic apparatus, the insulating portion on the surface is charged by triboelectric charging between the developing roller and the toner, and injection charging for injecting charges by a potential difference between the developing roller and another contact member, mainly, a developing blade. When the insulating portion is charged, a microelectric field due to a potential difference is formed between the charged insulating portion and a conductive portion which has high conductivity and is not charged. Due to this microelectric field, a gradient force, which is a force in the direction of the outer surface of the developing roller, is generated around the developing roller. Since the toner around the developing roller is attracted to the developing roller by this gradient force, the developing roller can transport a sufficient amount of the toner even when the drive torque between the toner supply roller and the developing roller is reduced.

In addition, if the insulating portion is charged by injection charging, it is less susceptible to the influence of factors other than the developing roller, such as the state of the toner, compared with triboelectric charging, and the toner transporting force can be stably ensured.

Japanese Patent Application Publication No. 2020-020958 discloses a developing roller that can prevent image density non-uniformity resulting from non-uniformity of a toner transporting force even if the developing roller and the toner supply roller output an image with reduced torque after the developing roller and the toner supply roller are left in a high-temperature and high-humidity environment.

### SUMMARY

However, according to the studies made by the inventors, in the developing roller disclosed in Japanese Patent Application Publication No. 2020-020958, the toner transporting force was sometimes reduced when the roller was used for a long period of time without being replaced in a high-temperature and high-humidity area with a reduced drive torque.

If the developing roller is used without replacement, it will be used for a period of several times longer than if it is replaced integrally with the process cartridge. When the developing roller is used for a long period of time in a high-temperature and high-humidity environment, the entire developing roller is in a moisture-absorbed state, and the resistance of the insulating portion is reduced. In this state, particularly if the insulating portion is to be charged by injection charging, the insulating portion is not sufficiently charged, and toner transport failure (image density decrease or image blank dots) may occur.

The present disclosure provides a developing roller that has a high process speed, and exhibits a sufficient toner transporting force and can prevent toner transport failure even when the developing roller is used in various environments for a long period of time with a reduced drive torque. Another aspect of the present disclosure provides a process cartridge including the developing roller. Still another aspect of the present disclosure provides an electrophotographic image forming apparatus including the process cartridge.

The present disclosure relates to a developing roller, comprising: a substrate having a conductive outer surface; and a conductive layer on the outer surface of the substrate, wherein an outer surface of the developing roller is formed of at least a first region and a second region having higher conductivity than the first region, the first region and the second region are placed adjacent to each other, the first region is placed on an outer surface of the conductive layer, when a metal film is directly provided on the outer surface of the developing roller, and while changing a frequency between 1.0×10⁻¹ to 1.0×10⁵ Hz, an AC voltage with an amplitude of 50 V is applied between the outer surface of the substrate and the metal film while a DC voltage of 50 V is applied in an environment at a temperature of 23° C. and a relative humidity of 50%, an impedance at a frequency of 1.0×10⁰ to 1.0×10¹ Hz is 1.0×10⁶Ω or more, in a case where when a corona discharger having a grid portion with a width of 3.0 mm is placed in an environment at a temperature of 23° C. and a relative humidity of 50% such that a distance between the grid portion and the outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, the potential at t=0.06 [sec] is denoted by V_{INI} [V], a change in the potential at 30.00≤t≤100.00 is fitted to a formula (X′) below by a least squares method to obtain V_{0,1} [V] and τ₁ [sec], when a value of a potential V₁(t) at the time of substituting t=0.06 [sec] into the formula (X′) is denoted by V₁ [V], V_{INI}−V₁ is less than 20.0 V.

$${V}_{1} ( t ) = {V}_{0 , 1} exp ( - t / {τ}_{1} ) \qquad ( {X}^{′} )$$

Further, the present disclosure relates to a process cartridge configured to be attachable to and detachable from a main body of an electrophotographic image forming apparatus, the process cartridge comprising a developing unit, wherein the developing unit comprises the developing roller of the present disclosure.

Furthermore, the present disclosure relates to an electrophotographic image forming apparatus comprising a developing unit, wherein the developing unit comprises the developing roller of the present disclosure.

According to the present disclosure, it is possible to provide a developing roller that has a high process speed, and can prevent toner transport failure even when the developing roller is used in various environments for a long period of time with a reduced drive torque, and a process cartridge, and an electrophotographic image forming apparatus.

Features of the present disclosure will become apparent from the following description of embodiments with reference to the attached drawing. The following description of embodiments is described by way of example.

### BRIEF DESCRIPTION OF THE DRAWINGS

FIG. 1A is a schematic cross-sectional view showing an example of a developing roller, and FIG. 1B is a schematic outer surface view showing an example of a developing roller.

FIG. 2 is a schematic cross-sectional view showing another example of the developing roller.

FIG. 3 is a schematic view of a process cartridge.

FIG. 4 is a schematic view of an electrophotographic image forming apparatus.

FIG. 5 is a schematic view showing a state in which a measuring electrode is formed on a developing roller.

FIG. 6 is a cross-sectional view of the developing roller and the measuring electrode.

FIG. 7 is a schematic view of an impedance measurement system.

FIG. 8 is a schematic view showing an example of an apparatus for measuring the surface potential of a developing roller.

FIG. 9 is a schematic view of a circuit for measuring a leakage current flowing from a toner to a developing roller.

FIG. 10 is a schematic view of an electrophotographic image forming apparatus for image evaluation.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. In a case where numerical ranges are described stepwise, an upper limit and a lower limit of each numerical range can be arbitrarily combined. In addition, in the present disclosure, the description such as “at least one selected from the group consisting of XX, YY, and ZZ” means any of XX, YY, and ZZ, a combination of XX and YY, a combination of XX and ZZ, a combination of YY and ZZ, or a combination of XX, YY, and ZZ. In a case where XX is a group, a plurality of members may be selected from XX, and the same is true for YY and ZZ.

The inventors have estimated the reason why the insulating portion is not sufficiently charged and the toner transporting force is insufficient and the image density decreases when the developing roller according to Japanese Patent Application Publication No. 2020-020958 is used for a long period of time in a high-temperature and high-humidity environment as follows.

When a process cartridge including a developing roller is left in a high-temperature and high-humidity environment without operation, a difference in humidity occurs between the outside of the process cartridge and the inside of the process cartridge partitioned by the developing roller. Thus, the moisture absorption amount of the outer surface of the developing roller located outside of the process cartridge and the moisture absorption amount of the outer surface of the developing roller located inside are non-uniform, which results in non-uniform charge retention and electric resistance of the insulating portion. As a result, image density non-uniformity occurs due to the occurrence of non-uniformity of a gradient force, that is, a toner transporting force.

According to the developing roller of Japanese Patent Application Publication No. 2020-020958, by incorporating a resin having low hygroscopicity in the vicinity of the surface of a conductive elastic layer, moisture diffusing into the conductive elastic layer is reduced, the amount of moisture adhering to the insulating portion present on the outer surface of the conductive elastic layer is reduced, and image density non-uniformity can be prevented. However, in a situation where a process cartridge is continuously used for a long period of time without being replaced in a high-temperature and high-humidity environment, moisture gradually diffuses into the process cartridge, and the humidity inside of the process cartridge rises to the same level as the humidity outside of the process cartridge. Furthermore, moisture diffuses throughout the entire developing roller, and eventually moisture is absorbed until the entire developing roller is saturated. Even if a resin having low hygroscopicity is incorporated in the vicinity of the surface, when moisture is absorbed until the entire developing roller is saturated, the electric resistance of the insulating portion in the entire outer surface of the developing roller decreases both inside and outside of the process cartridge. As a result, the insulating portion is not sufficiently charged, the toner transporting force is insufficient, and toner transport failure (image density decrease or image blank dots) occurs.

The inventors have considered that the reason why the moisture-absorbed insulating portion is less likely to be charged by injection charging is that while injection of charges into the insulating portion occurs due to a potential difference between the developing roller and another contact member, leakage of charges from the insulating portion to the conductive portion of the developing roller is also prominent. That is, the inventors have considered that if the leakage of charges from the insulating portion to the conductive portion can be prevented, the insulating portion can be sufficiently charged even if the insulating portion absorbs moisture.

Specifically, it was attempted to prevent charge leakage from the insulating portion by increasing the resistance of the conductive portion. For example, as a result of evaluating the image density after a developing roller in which a conductive portion having high resistance is formed using a polyurethane and an insulating portion is further formed is left for a long period of time in a high-temperature and high-humidity environment, it was found that toner transport failure can be prevented. However, it was found that when the developing roller is used in a low-temperature and low-humidity environment, a new problem that toner transport failure occurs conversely arises. This is considered to be because the resistance of the conductive portion is increased, and therefore the charges injected into the conductive portion is not quickly removed due to the potential difference between the developing roller and another contact member. It is considered that not only the insulating portion but also the conductive portion are charged due to the fact that charges are not removed from the conductive portion, and the potential difference between the conductive portion and the insulating portion decreases, and a sufficient gradient force cannot be exhibited, resulting in occurrence of toner transport failure.

Therefore, the inventors conducted studies for achieving both prevention of charge leakage from the insulating portion to the conductive portion and removal of charges from the conductive portion by, for example, adjusting the blending amount and type of a conductive filler to be incorporated in a polyurethane forming the conductive portion. However, it was found that only simple adjustment of the blending amount and type of a conductive filler leads to a trade-off relationship between the two, and it is difficult to achieve both prevention of toner transport failure in the case of long-term use in a high-temperature and high-humidity environment and prevention of toner transport failure in a low-temperature and low-humidity environment.

That is, the inventors recognized that it is necessary to develop a new conductive portion in order to solve at a high level the contradictory problems of preventing charge leakage from the insulating portion to the conductive portion in a high-temperature and high-humidity environment and removing charges from the conductive portion in a low-temperature and low-humidity environment. On the basis of such recognition, the inventors further conducted studies.

As a result, it was recognized that it is effective to satisfy the following two requirements in order to solve the above two problems for a developing roller including a substrate having a conductive outer surface and a conductive layer on the outer surface of the substrate, in which an outer surface of the developing roller is formed of at least a first region and a second region having higher conductivity than the first region, the first region and the second region are placed adjacent to each other, and the first region is placed on an outer surface of the conductive layer.

### Requirement (1)

When a metal film is directly provided on an outer surface of a developing roller, and while changing a frequency between 1.0×10⁻¹ to 1.0×10⁵ Hz, an AC voltage with an amplitude of 50 V is applied between an outer surface of the substrate and the metal film while a DC voltage of 50 V is applied in an environment at a temperature of 23° C. and a relative humidity of 50%, an impedance at a frequency of 1.0×10° to 1.0×10¹ Hz is 1.0×10⁶Ω or more.

### Requirement (2)

In a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, the potential at t=0.06 [sec] is denoted by V_{INI} [V], a change in the potential at 30.00≤t≤100.00 is fitted to formula (X′) below by a least squares method to obtain V_{0,1} [V] and τ₁ [sec], when a value of a potential V₁(t) at the time of substituting t=0.06 [sec] into formula (X′) is denoted by V₁ [V], V_{INI}−V₁ is less than 20.0 V.

$${V}_{1} ( t ) = {V}_{0 , 1} exp ( - t / {τ}_{1} ) \qquad ( {X}^{′} )$$

The above requirements (1) and (2) will be described in detail below.

### Technical Significance of Requirement (1)

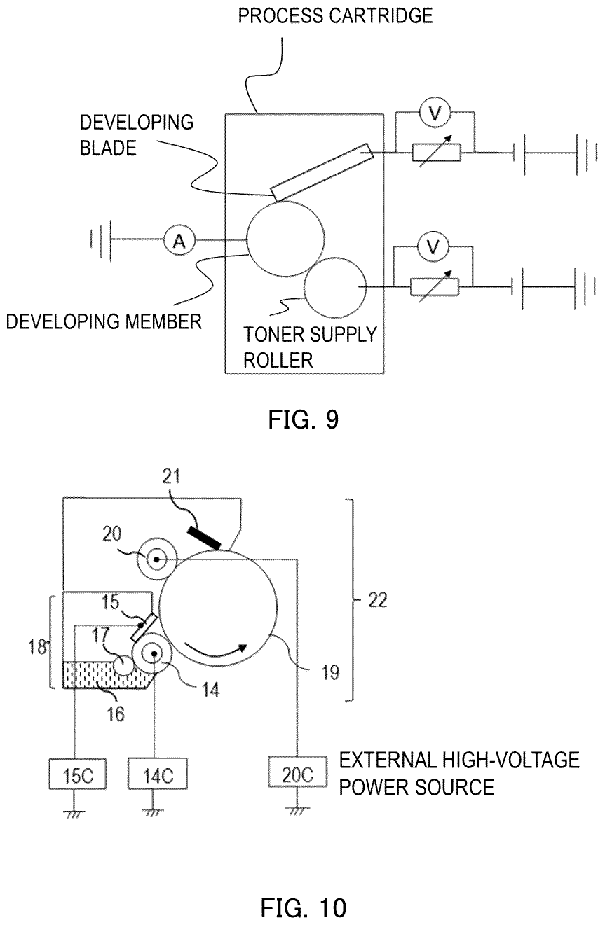

The requirement (1) defines a numerical value of the impedance of the developing roller. This impedance is a physical property value showing the property of charge leakage from the first region forming the outer surface of the developing roller, that is, the insulating portion to the second region, that is, the conductive portion. The inventors measured a current value (leakage current value) flowing through the developing roller when a blade bias is applied to a developing blade according to a circuit diagram shown in FIG. 9. As a result, it was found that this current value shows a higher correlation with the impedance value of the developing roller than the electric resistance value of the developing roller.

Furthermore, it was found that, when the outer surface of the developing roller is formed of an insulating portion (first region) and a conductive portion (second region), the impedance value exhibits the property of the conductive portion having higher conductivity.

That is, charge leakage indicates that not only a resistance component of the developing roller (conductive portion) but also the influence of an electrostatic capacitance component needs to be considered. This is considered to be because when the electrical characteristics of the developing roller are pseudo-represented by an RC parallel circuit, charges are sufficiently accumulated in a capacitor component, and the transient state to the steady state in which a resistance component is dominant has a large influence on the charge leakage.

The voltage application condition for impedance measurement is that an AC voltage of 50 V is superposed on a DC voltage of 50 V. That is, sine waves with the minimum and maximum values of the applied voltage of 0 V and 100 V (Vpp 100 V) are applied. The value of Vpp100 V is a value obtained by assuming the maximum value of the shared voltage applied to the developing roller when a voltage is applied so that a voltage difference of 300 V is applied between the developing roller and the developing blade in the electrophotographic image forming apparatus.

Although the impedance exhibits bias dependence and has a property of decreasing the impedance with increasing bias, it has been found that the degree of decrease varies depending on the developing roller. While the voltage application condition is generally an AC voltage of 1 V in the conventional impedance measurement of the developing roller, the AC voltage of 1 V is clearly lower than the voltage (generally several hundred volts) applied between the developing roller and the developing blade in an actual electrophotographic image forming apparatus. For this reason, the behavior of the developing roller in the electrophotographic image forming apparatus is often not simulated, and the impedance measurement conditions are often inadequate.

Therefore, in the present disclosure, a voltage application condition simulating a high blade bias applied to an actual electrophotographic image forming apparatus is adopted. The sine wave with the minimum applied voltage of 0 V simulates a rectangular wave commonly used for applying the blade bias of the actual electrophotographic image forming apparatus.

In the present disclosure, an impedance at a frequency of 1.0×10⁰ to 1.0×10¹ Hz is specified, and the low frequency range of the frequency of 1.0×10⁰ to 1.0×10¹ Hz is a region where the transient state is completed and a steady state in which the resistance component is dominant is reached. That is, the influence of both the electrostatic capacitance component and the resistance component is reflected, and this is a region suitable for ascertaining the property of charge leakage from the insulating portion to the conductive portion. When the impedance at a frequency of 1.0×10⁰ to 1.0×10¹ Hz is 1.0×10⁶Ω or more, the charge leakage property of the conductive layer is low, the charge leakage from the insulating portion to the conductive layer is prevented under a high blade bias, and the toner transport failure can be prevented.

The impedance at the frequency of 1.0×10⁰ to 1.0×10¹ Hz is preferably 1.4×10⁶Ω or more. The value of the impedance is preferably as high as possible, and the upper limit thereof is not particularly limited, and is, for example, 5.0×10⁷Ω or less.

The impedance at a frequency of 1.0×10⁰ to 1.0×10¹ Hz is preferably 1.4×10⁶Ω or more, more preferably 2.0×10⁶Ω or more, particularly preferably 3.0×10⁶Ω or more, and even more preferably 5.0×10⁶Ω or more. A preferable range of the impedance is from 1.0×10⁶Ω to 5.0×10⁷Ω, preferably from 1.4×10⁶Ω to 5.0×10⁷Ω, more preferably from 2.0×10⁶Ω to 5.0×10⁷Ω, particularly preferably from 3.0×10⁶Ω to 5.0×10⁷Ω, even more preferably from 5.0×10⁶Ω to 5.0×10⁷Ω.

### Technical Significance of Requirement (2)

The requirement (2) specifies the surface potential of the outer surface of the developing roller. This surface potential corresponds to the surface potential of the conductive portion which is the second region. The surface potential of the conductive portion indicates ease of remaining of charges in the conductive portion, and as the surface potential is higher, it becomes difficult to remove charges injected into the conductive portion, the potential difference between the conductive portion and the insulating portion decreases, and toner transfer failure is likely to occur.

In the present disclosure, when a voltage of 8 kV is applied to the grid portion and the corona discharger is relatively moved along the axial direction of the developing roller at a speed of 400 mm/sec, the decay behavior, that is, the relaxation curve, of the potential of the outer surface of the developing roller after the passage of the grid portion of the corona discharger is checked.

The relaxation curve of the surface potential of the developing roller whose outer surface is formed of a conductive portion and an insulating portion is a curve obtained by combining a relaxation curve corresponding to the conductive portion showing fast decay and a relaxation curve corresponding to the insulating portion showing slow decay. The relaxation curve is generally represented by formula (X) below.

$$V ( t ) = {V}_{0} exp ( - t / τ ) \qquad ( X )$$

In formula (X), V₀ represents the surface potential [V] when t=0, t represents the elapsed time [sec], and T represents the time constant [sec].

In addition, since the surface potential of the developing roller at 30.00≤t≤100.00 is considered to be less affected by the relaxation curve corresponding to the conductive portion showing fast decay, V₁(t) in a case where a change in the surface potential of the developing roller at 30.00≤t≤100.00 is fitted to formula (X′) below to obtain the values of V_{0,1} [V] and τ₁ [sec] is a relaxation curve corresponding to a region where charge decay is slow on the outer surface of the developing roller, that is, an insulating portion.

$${V}_{1} ( t ) = {V}_{0 , 1} exp ( - t / {τ}_{1} ) \qquad ( {X}^{′} )$$

In formula (X′), V_{0,1} represents the surface potential [V] of the insulating portion when t=0, and τ₁ represents the time constant [sec] of the insulating portion.

Therefore, V₁, which is a value when t=0.06 is substituted into the potential V₁(t), represents the surface potential of the insulating portion at 0.06 seconds after passage of the grid portion of the corona discharger.

On the other hand, V_{INI} is an actual measurement of the surface potential of the outer surface of the developing roller including the conductive portion and the insulating portion at 0.06 seconds after passage of the grid portion of the corona discharger. That is, the surface potential of the conductive portion at 0.06 seconds after passage of the grid portion of the corona discharger can be represented by V_{INI}−V₁.

If the surface potential of the conductive portion is less than 20.0 V, charges injected into the conductive portion when passing through a contact member such as a developing blade or a photosensitive drum can be removed quickly. Therefore, even if the conductive portion repeatedly passes through the developing blade or a photosensitive drum by the rotation of the developing roller, no charges are accumulated and no static electricity is generated in the conductive portion, and a potential difference between the conductive portion and the insulating portion does not decrease, so that toner transport failure can be prevented.

A time at 0.06 seconds after passage of the grid portion of the corona discharger simulates a time until the conductive portion of the developing roller reaches the contact position with another contact member, such as the photosensitive drum, after passage of the developing blade in a model with a high process speed. Thus, in an electrophotographic image forming apparatus with a high process speed, even when triboelectric charging with not only the developing blade but also the photosensitive drum or the like, or injection charging is performed, charges are not accumulated in the conductive portion, and toner transport failure can be prevented.

The surface potential (V_{INI}−V₁) of the conductive portion is preferably 15.0 V or less, and more preferably 10.0 V or less. The surface potential of the conductive portion is preferably as low as possible, and the lower limit is not particularly limited.

The surface potential of the conductive portion is preferably, for example, 0.0 V or more and less than 20.0 V, particularly from 0.0 V to 15.0 V, and even more preferably, from 0.0 V to 10.0 V.

When the developing roller satisfies the above requirements (1) and (2), it is possible to achieve at high level both the contradictory problems of preventing charge leakage from the insulating portion to the conductive portion in a high-temperature and high-humidity environment and removing charges from the conductive portion in a low-temperature and low-humidity environment. As a result, even when the developing roller is used for a long period of time in various environments with a reduced drive torque, toner transport failure can be prevented.

A method for satisfying the above requirements (1) and (2) is not particularly limited. Specifically, as will be described later, use of a material for the conductive layer, a material for the conductive filler, and an additive as described below can be exemplified.

Hereinafter, the present disclosure will be described in detail.

### Developing Roller

A developing roller includes a substrate having a conductive outer surface and a conductive layer on the outer surface of the substrate. An outer surface of the developing roller is formed of at least a first region (insulating portion) and a second region (conductive portion) having higher conductivity than the first region, the first region and the second region are placed adjacent to each other, and the first region is placed on an outer surface of the conductive layer.

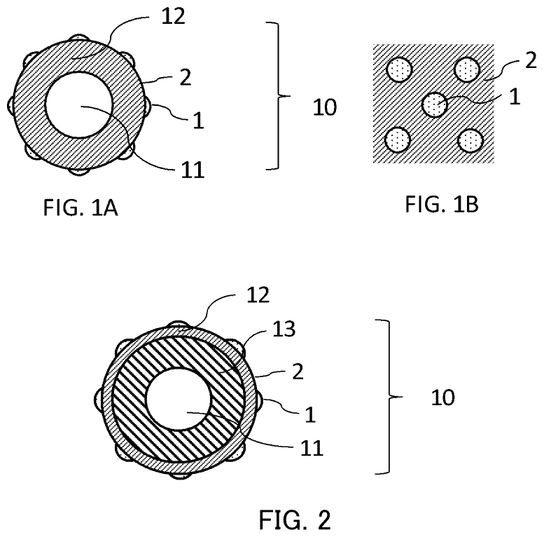

An example of a schematic cross-sectional view of the developing roller is shown in FIG. 1A and an example of a schematic outer surface view is shown in FIG. 1B. In the developing roller 10 shown in FIG. 1A, a conductive layer 12 is laminated on the outer peripheral surface of a substrate 11 in a cylindrical or hollow tubular shape. Further, the outer surface of the developing roller is formed of a first region 1 and a second region 2 having higher conductivity than the first region, and the second region 2 is formed of the outer surface of the conductive layer 12. The first region 1 is formed of an outer surface of an insulator disposed on the outer surface of the conductive layer 12 so that the outer surface of the conductive layer is exposed. The first region may be configured by disposing an insulator on an outer surface of the conductive layer 12, or may be configured by exposing an insulator incorporated in the conductive layer 12.

Note that the configuration of the layer of the developing roller is not limited to the configuration shown in FIG. 1A. Another embodiment of the developing roller is, as shown in FIG. 2, a developing roller having an elastic layer 13 between a substrate 11 and a conductive layer 12 provided on the outer peripheral surface of the substrate 11.

### Substrate

The substrate is electrically conductive and functions as a support member for a developing roller and, in some cases, an electrode. Specific examples of the substrate include solid cylindrical and hollow tubular substrates.

Materials forming the substrate may be selected, as appropriate, from those known in the field of electrophotographic conductive members and materials available as such a developing roller. Examples thereof include metals represented by aluminum and stainless steel, carbon steel alloys, conductive synthetic resins, and metals or alloys such as iron and copper alloys.

Furthermore, the material forming the substrate may be subjected to oxidation treatment or plating treatment with chromium, nickel, or the like. As the type of plating, either electroplating or electroless plating may be used. From the viewpoint of dimensional stability, electroless plating is preferable. Examples of the type of electroless plating used here may include nickel plating, copper plating, gold plating, and other various types of alloy plating. The plating thickness is preferably 0.05 μm or more, and the plating thickness is preferably 0.1 to 30 μm in consideration of the balance between working efficiency and antirust ability.

A primer may be applied to the surface of the substrate in order to improve the adhesion between the substrate and the conductive layer or the elastic layer. As the primer, known primers can be selected and used in accordance with a rubber material for forming the conductive layer, a material of a support, and the like. Examples of the material for the primer may include a thermosetting resin or a thermoplastic resin, and specific examples may include materials such as a phenolic resin, a polyurethane, an acrylic resin, a polyester resin, a polyether resin, and an epoxy resin.

### Conductive Layer and Second Region (Conductive Portion)

The developing roller has a conductive layer on an outer surface of a substrate. The outer surface of the developing roller is formed of at least a first region and a second region having higher conductivity than the first region.

That is, the conductive layer is provided on the outer surface of the substrate, and the second region (conductive portion) forming the outer surface of the developing roller is formed of the outer surface of the conductive layer. The conductive layer may contain a binder resin.

### Binder Resin

As the binder resin of the conductive layer, a polyurethane is preferably used to prevent charge leakage from the insulating portion to the conductive layer, and more preferably, a polyurethane having a polycarbonate structure is used. That is, the conductive layer preferably contains a polyurethane, and more preferably contains a polyurethane having a polycarbonate structure. When the polyurethane has a polycarbonate structure, the surface strength is high, and the electric resistance can be made favorable, so that the properties as the developing roller can be easily maintained through durability.

Furthermore, in order to sufficiently maintain the flexibility of the conductive layer for reducing the load on the toner and the wear resistance of the conductive layer while preventing charge leakage from the insulating portion to the conductive layer, it is more preferable to use a polyurethane having a structure described below as the binder resin of the conductive layer.

It is preferable that the conductive layer contains a polyurethane, and the polyurethane satisfies at least two of the following (A), (B), and (C). All of the following (A), (B), and (C) may be satisfied:
(A) the polyurethane has a structure represented by structural formula (1) below in a molecule;
(B) the polyurethane has one or both structures of a structure represented by structural formula (2) below and a structure represented by structural formula (3) below in a molecule; and
(C) the polyurethane has a structure represented by structural formula (4) below in a molecule.

In other words, the polyurethane preferably satisfies at least one of the following:
Having at least a structure represented by structural formula (1) and a structure represented by structural formula (2);
Having at least a structure represented by structural formula (1) and a structure represented by structural formula (3);
Having at least a structure represented by structural formula (1) and a structure represented by structural formula (4);
Having at least a structure represented by structural formula (2) and a structure represented by structural formula (4); and
Having at least a structure represented by structural formula (3) and a structure represented by structural formula (4).

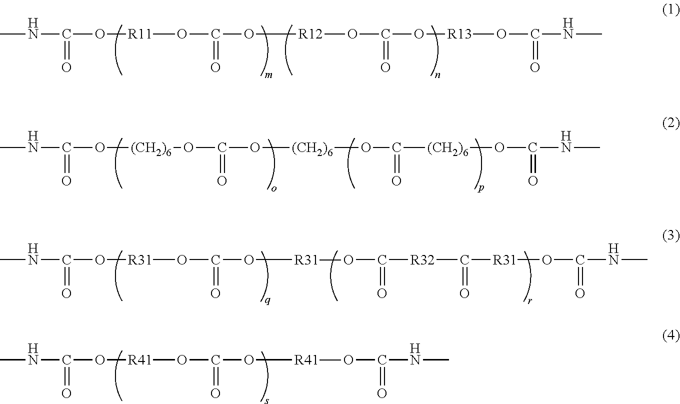

In structural formula (1), R11, R12, and R13 represent a divalent hydrocarbon group having 3 to 9 carbon atoms, provided that R11 and R12 are different from each other, and R13 is the same as at least one selected from the group consisting of R11 and R12. m and n are average numbers of moles added, and each independently represent a number of 1.0 or more (preferably 1.0 to 20.0, more preferably 2.0 to 12.0).

In structural formula (2), o and p are average numbers of moles added, and each independently represent a number of 1.0 or more (preferably 1.0 to 15.0, more preferably 4.0 to 10.0).

In structural formula (3), R31 and R32 each independently represent a divalent hydrocarbon group having 3 to 8 carbon atoms. q and r are average numbers of moles added, and each independently represent a number of 1.0 or more (preferably 1.0 to 20.0, more preferably 2.0 to 14.0).

In structural formula (4), R41 represents a divalent hydrocarbon group having 6 to 9 (preferably 5 to 8) carbon atoms. s is an average number of moles added, and represents a number of 1.0 or more (preferably 1.0 to 22.0, more preferably 4.0 to 18.0).

The structure represented by structural formula (1) is a structure resulting from a reaction of a copolymerized polycarbonate polyol in which crystallinity is reduced by bonding two carbonate groups with two different types of hydrocarbon groups with an isocyanate. Because crystallinity is reduced, aggregation energy in a soft segment is small, and flexibility and a high volume resistivity can be imparted to the conductive layer.

The adhesiveness of the conductive layer can be reduced by using the structure of structural formula (1) in combination with the structures of (2) to (4) described above for the conductive layer. Thus, it is possible to prevent the adhesion of a toner, a powder, or the like to the surface of the conductive layer, so that an increase in the electric resistance value of the surface of the conductive layer due to dirt is prevented, and it becomes easier to quickly remove charges injected into the conductive portion.

In structural formula (1), R11 and R12 are each independently a divalent hydrocarbon group having 3 to 9 carbon atoms. R11 and R12 are different from each other, and R13 is the same as at least one selected from the group consisting of R11 and R12.

When the number of carbon atoms in R11 and R12 is 3 or more, the amount of carbonate groups that are polar functional groups and have strong aggregation energy is not too large in the polyurethane, and the conductive layer is easily kept flexible and with a high electric resistance.

When the number of carbon atoms in R11 and R12 is 9 or less, the amount of carbonate groups in the polyurethane is not too small, and the strength of the polymer can be maintained. In addition, since R11 and R12 have different structures, crystallinity of the polymer is reduced, and flexibility can be imparted to the conductive layer. m and n each independently represent a number of 1.0 or more. The hydrocarbon groups represented by R11, R12, and R13 may have a branched structure or a cyclic structure.

The structures represented by structural formula (2) and structural formula (3) are structures resulting from a reaction of a copolymer polyol obtained by copolymerizing a polycarbonate structure and a polyester structure with an isocyanate. The crystallinity of the polymer is reduced by copolymerizing a polycarbonate structure and a polyester structure, and a soft segment is moderately reinforced by introducing an ester group having stronger aggregation energy than a carbonate group, so that wear resistance can be imparted to the conductive layer.

When the conductive layer is formed using a polymer in which the structure represented by structural formula (2) and/or structural formula (3) is combined with the structure of formula (1) or (4) described above, it is possible to impart a sufficient volume resistivity to the conductive layer while having an ester group with polarity, and it becomes easier to prevent charge leakage from the insulating portion to the conductive layer.

In structural formula (2), o and p are each independently represent a number of 1.0 or more.

In structural formula (3), R31 and R32 each independently represent a divalent hydrocarbon group having 3 to 8 carbon atoms, and q and r are each independently represent a number of 1.0 or more. When the number of carbon atoms in R31 and R32 is 3 or more, the amount of carbonate groups and ester groups which are polar functional groups and have strong aggregation energy is not too large in the polyurethane, and the conductive layer can be kept flexible. When the number of carbon atoms in R31 and R32 is 8 or less, the amount of carbonate groups and ester groups in the polyurethane is not too small, and wear resistance can be imparted to the conductive layer.

The structure represented by structural formula (4) is a structure resulting from a reaction of a highly crystalline polycarbonate polyol in which two carbonate groups are bonded with a single hydrocarbon group with an isocyanate.

This structure has high crystallinity and is easily arranged in a soft segment, so that wear resistance and a high volume resistivity can be imparted to the conductive layer. By forming the conductive layer using a polymer in which the structure represented by structural formula (4) is combined with the structures of formulae (1) to (3) described above, the hardness of the conductive layer is not too high and is easy to control properly.

In structural formula (4), R41 represents a divalent hydrocarbon group having 6 to 9 carbon atoms, and s represents a number of 1.0 or more. When the number carbon atoms in R41 is 6 or more, crystallinity is easily exhibited, and wear resistance and a high volume resistivity can be imparted to the conductive layer. When the number carbon atoms in R41 is 9 or less, excessive crystallinity can be prevented, and therefore by further incorporating at least one of the structures represented by structural formulae (1), (2), and (3) in the polymer, an increase in hardness of the conductive layer can be prevented.

The conductive layer preferably contains a polymer having a urethane bond, that is, a polyurethane as the binder resin, and the polymer preferably satisfies at least two selected from the group consisting of the above (A), (B), and (C). As a result, the conductive layer is flexible and less worn.

The structure of the polymer contained in the conductive layer of the developing roller can be checked by, for example, analysis by pyrolysis GC/MS, FT-IR, or NMR.

The polyurethane can be produced using a polyol compound (A) and a polyisocyanate compound (B). Usually, the following methods (1) and (2) are used for the synthesis of the polyurethane.
(1) A one-shot method in which a polyol component and a polyisocyanate component are mixed and allowed to react with each other
(2) A method in which an isocyanate group-terminated prepolymer obtained by a reaction of a part of a polyol with an isocyanate, and a chain extender such as a low molecular diol or a low molecular triol are allowed to react with each other

In the present disclosure, the polyurethane may be synthesized by any of the methods described above, and a method in which a hydroxyl group-terminated prepolymer resulting from a reaction of a raw polyol with an isocyanate and an isocyanate group-terminated prepolymer resulting from a reaction of a raw polyol with an isocyanate are subjected to a thermal curing reaction is more preferable.

The polyurethane is preferably a reaction product of a mixture containing a hydroxyl group-terminated prepolymer and an isocyanate group-terminated prepolymer. The mixture can be used as a conductive layer-forming coating liquid. The polyurethane is more preferably a reaction product of a mixture containing a hydroxyl group-terminated prepolymer, an isocyanate group-terminated prepolymer, a conductive filler, and an additive.

When there are many hydroxyl groups, isocyanate groups, urea bonds, allophanate bonds, isocyanurate bonds, and the like, the water absorbability of the polymer may increase and the volume resistivity of the conductive layer may decrease because many polar functional groups are present in the polyurethane. Meanwhile, by thermal curing the hydroxyl group-terminated prepolymer and the isocyanate group-terminated prepolymer, a polyurethane with less unreacted polyols and polar functional groups can be obtained without excessive use of an isocyanate. Therefore, it is preferable from the viewpoint of further preventing charge leakage from the insulating portion to the conductive layer.

### Polyol Compound (A)

As the polyol compound, a polyol known for the synthesis of a urethane resin or capable of being used for the synthesis of a urethane resin can be used. Examples of the polyol compound include the following polyol compounds: polyolefin polyols, such as a polycarbonate polyol, a polyether polyol, a polyester polyol, a polybutadiene polyol, and a polyisoprene polyol, a so-called polymeric polyol obtained by polymerization of an ethylenically unsaturated monomer in a polyol, and a polyester-polycarbonate copolymer polyol.

Among them, the polyol compound is preferably at least one selected from the group consisting of a polycarbonate polyol and a polyester-polycarbonate copolymer polyol.

Examples of the polycarbonate polyol include the following polycarbonate polyols: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random or block copolymers thereof.

Examples of the polyester-polycarbonate copolymer polyol may include the following polyester-polycarbonate copolymer polyols: a copolymer obtained by polycondensation of the polycarbonate polyol with a lactone such as F-caprolactone, and a copolymer of a diol such as 1,4-butanediol, 1,5-pentanediol, 1,6-hexanediol, 3-methylpentanediol, or neopentyl glycol with a polyester obtained by polycondensation of a dicarboxylic acid such as adipic acid or sebacic acid.

### Polyisocyanate Compound (B)

The polyisocyanate is selected from commonly used known polyisocyanates, and examples thereof include the following polyisocyanates: toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among them, aromatic isocyanates such as toluene diisocyanate (TDI), diphenylmethane diisocyanate (MDI), polymeric diphenylmethane polyisocyanate, and polymeric MDI are more suitably used. Other polyisocyanates can also be used as long as they do not affect the impedance value and the surface potential.

The ratio of the number of isocyanate groups to the number of hydroxyl groups (hereinafter also referred to as “NCO/OH ratio”) is preferably 1.0 to 2.0. If the NCO/OH ratio is 1.0 to 2.0, the crosslinking reaction proceeds, and the oozing, so-called “bleeding” of unreacted components or low molecular weight polyurethanes is prevented. This NCO/OH ratio is more preferably 1.0 to 1.6. If the NCO/OH ratio is 1.0 to 1.6, bleeding is prevented, and the hardness of the polymer can be reduced.

The content of the polyurethane in the conductive layer is not particularly limited, but preferably 50 to 95 mass %, more preferably 60 to 80 mass %, and even more preferably 65 to 75 mass %.

### Conductive Filler

The conductive layers preferably contain a conductive filler in order to obtain conductivity. It is more preferable to use an electron conductive agent as the conductive filler in the conductive layer. The electron conductive agent is preferably a conductive particle exhibiting electron conductivity, and preferably has a surface functional group capable of interacting with a functional group present in an additive to be described later.

Examples of the electron conductive agent exhibiting these properties include at least one selected from the group consisting of carbon blacks such as furnace black, thermal black, acetylene black, and Ketjen black, metal oxide-based conductive particles such as titanium oxide having a surface treated with an acidic functional group, and metal-based conductive particles such as aluminum or iron having a surface treated with an acidic functional group.

Among them, at least one selected from the group consisting of carbon blacks having high stability of the surface functional group is suitably used. The conductive filler preferably contains a carbon black. Furthermore, in order to obtain a desired impedance value and surface potential, a carbon black in which the number average diameter of primary particles that can achieve higher dispersion in the conductive layer is 30 nm or less, the DBP absorption amount is 90 ml/100 g or less, and the pH is 4.0 or less is particularly suitably used.

When the number average diameter of primary particles of the carbon black is 30 nm or less, an aggregate (primary aggregate), which is a smallest dispersible unit of the carbon black, becomes small, and a structure (size of connection of particles) also becomes small, so that a conductive path is less likely to be formed. Therefore, a sufficiently high impedance is easily obtained. The primary particle diameter of the carbon black can be calculated with a transmission electron microscope (TEM). The lower the number average diameter, the more preferable, and the lower limit is not particularly limited. For example, the number average diameter of primary particles of the carbon black is more preferably 5 to 30 nm or 20 to 28 nm.

When the DBP absorption amount of the carbon black is 90 ml/100 g or less, the carbon black structure becomes small, and a conductive path is less likely to be formed, so that a sufficiently high impedance is easily obtained. The lower the DBP absorption amount, the more preferable, and the lower limit is not particularly limited. For example, the DBP absorption amount of the carbon black is preferably 30 to 90 ml/100 g, more preferably 40 to 60 ml/100 g.

When the pH of the carbon black is 4.0 or less, an effect of dispersion stability is obtained by repulsion of the surface functional group of the carbon black, and aggregation of the carbon black is less likely to occur, so that a sufficiently high impedance is easily obtained. The lower the pH of the carbon black, the more preferable, and the lower limit is not particularly limited. For example, the pH of the carbon black is preferably 2.0 to 4.0, more preferably 2.2 to 2.8.

However, even if the number average diameter of primary particles, DBP absorption amount, and pH of the carbon black are within the above ranges, when polycarbonate urethane is used as the binder resin, the resin cannot be sufficiently dispersed, and a desired impedance may not be obtained. The reason why the carbon black, which is a desired raw material property, cannot be dispersed when polycarbonate urethane is used as the binder resin is not clearly known, but is presumed as follows.

The hydroxyl group, which is the surface functional group of the carbon black, tends to interact with the terminal hydroxyl group of the polycarbonate diol. Meanwhile, the structure in which the carbonate bond and the hydrocarbon group are bonded, which is present between the two hydroxyl groups of the polycarbonate diol, is hydrophobic due to the presence of the hydrocarbon group, and is difficult to interact with the carbon black. Since the structure is more stable when hydrophobic sites are present near each other or when hydrophilic sites are present near each other, a hydrophilic carbon black is present near the same hydrophilic carbon black. As a result, the carbon black tends to aggregate and is considered to be hardly dispersed.

In order to sufficiently disperse the carbon black in which the number average diameter of primary particles, DBP absorption amount, and pH are in the above numerical ranges using polycarbonate urethane as the binder resin, it is more preferable to add an additive to be described later.

The carbon black is desirably added to achieve a desired volume resistivity, and the content of the carbon black is preferably 30 parts by mass or less with respect to 100 parts by mass of the polyurethane forming the conductive layer. The content is more preferably 10 to 30 parts by mass, and still more preferably 15 to 25 parts by mass.

When the content is 30 parts by mass or less, the distance between the carbon black particles in the coating liquid is moderately maintained, the collision probability due to Brownian motion or the like of the carbon black is reduced, and the carbon black is less likely to aggregate. As a result, the carbon black is easily dispersed, and dispersion stability is also improved. As a result, the carbon black is well dispersed in the conductive layer formed by depositing the coating liquid.

In order to achieve the above specific impedance and surface potential, it is preferable to control the dispersion of the carbon black. As for the dispersed particle diameter of the carbon black, the arithmetic mean Rc of the circle-equivalent diameter of the carbon black in the conductive layer is preferably 60.0 nm or less. It is more preferable that when the standard deviation of the circle-equivalent diameter is denoted by as σc [nm], σc/Rc is 0.000 to 0.650.

As for the distance between carbon black particles, it is more preferable that the arithmetic mean d of the inter-wall distance of the carbon black in the conductive layer is 80.0 to 150.0 nm, and σd/d is 0.000 to 0.600 when the standard deviation of the inter-wall distance is denoted by σd [nm].

The reason why a high impedance and a low surface potential are more easily achieved when the circle-equivalent diameter and the inter-wall distance are in the above numerical ranges is estimated as follows.

When the dispersed particle diameter is large, there is a place where the inter-wall distance is short, and a conductive path is easily formed, and thus both impedance and surface potential decrease. On the other hand, when the dispersed particle diameter is reduced, the inter-wall distance approaches uniformity, and a conductive path is less likely to be formed, and the resistance increases, and thus the impedance increases. As for the surface potential, local charge accumulation is less likely to occur, and the surface potential can be decreased.

Note that multiple types of carbon blacks may be used in combination as long as they do not affect the impedance value and the surface potential.

The arithmetic mean Rc of the circle-equivalent diameter is more preferably 40.0 to 60.0 nm, and still more preferably 45.0 to 55.0 nm. σc/Rc is more preferably 0.500 to 0.650 and still more preferably 0.550 to 0.650.

The arithmetic mean Rc and standard deviation σc of the circle-equivalent diameter can be changed depending on the dispersion state in a mill or the like when preparing a conductive layer-forming coating liquid, for example. When the dispersion is weakened, Rc and σc tend to increase, and when the dispersion is strengthened, Rc and σc tend to decrease. Usually, Rc converges, and therefore beyond a certain dispersion state, σc can be decreased while Rc is left substantially constant, and it is possible to decrease σc/Rc.

The arithmetic mean d of the inter-wall distance is preferably 90.0 to 120.0 nm and more preferably 95.0 to 115.0 nm. σd/d is more preferably 0.500 to 0.600 and still more preferably 0.540 to 0.590.

The arithmetic mean d and standard deviation σd of the inter-wall distance can be changed depending on the dispersion state in a mill or the like when preparing a conductive layer-forming coating liquid, for example. When the dispersion is weakened, d tends to decrease and σd tends to increase, and when the dispersion is strengthened, d tends to increase and σd tends to decrease. Therefore, when the dispersion is weak, σd/d tends to increase, and when the dispersion is strong, σd/d tends to decrease.

### Additive

It is also one of the preferable aspects to use an additive to further improve the dispersibility of the carbon black in the binder resin using polycarbonate urethane. Here, as the additive, for example, at least one compound selected from the group consisting of a compound having a structure represented by structural formula (5) below, a compound having a structure represented by structural formula (6) below, and a compound having a structure represented by structural formula (7) below can be suitably used. In other words, it is preferable that the conductive layer contains at least one compound selected from the group consisting of a compound represented by structural formula (5) below, a compound represented by structural (6) below, and a compound represented by structural (7) below.

One of the methods of incorporating the above additive into the conductive layer is a method of incorporating a dispersing agent into a conductive layer-forming coating liquid. In a conductive layer formed using a conductive layer-forming coating liquid containing at least one compound selected from the group consisting of a compound having a structure represented by structural formula (5) and a compound having a structure represented by structural formula (6), the compound may be incorporated at the end of a polymer chain of a polyurethane. Even in such a case, the effect of improving the dispersibility of the carbon black can be expected, but it is preferable that the additive is present in the conductive layer independently of the polyurethane.

Among the compounds having structures represented by structural formulae (5) to (7), the compound having a structure represented by structural formula (5) is more suitably used because the dispersibility of the carbon black and the affinity for polycarbonate urethane are particularly excellent.

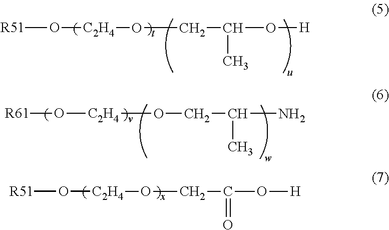

In structural formula (5), R51 represents a monovalent hydrocarbon group having 1 to 12 (preferably 3 to 12) carbon atoms, and t and u are average numbers of moles added, and each independently represent a number of 1.0 or more (preferably 5.0 to 30.0, more preferably 10.0 to 25.0).

In structural formula (6), R61 represents a monovalent hydrocarbon group having 1 to 8 (preferably 1 to 4) carbon atoms, and v and w are average numbers of moles added, and each independently represent a number of 1.0 or more (preferably 1.0 to 30.0, more preferably 5.0 to 30.0).

In structural formula (7), R71 represents a monovalent hydrocarbon group having 1 to 12 carbon atoms, and x is an average number of moles added, and represents a number of 1.0 or more (preferably 1.0 to 30.0 and more preferably 4.0 to 15.0).

Structural formula (5) is a polyoxyethylene polyoxypropylene alkyl ether, and is a polyether monool having a structure in which ethylene oxide and propylene oxide are addition-polymerized in a block form. The terminal hydroxyl group of the polyether monool interacts with the surface functional group of the carbon black, which is the conductive filler, by a hydrogen bond, and acts as a dispersing agent for the carbon black. In addition, in order to enhance the effect of the carbon black as the dispersing agent, it has a structure having good compatibility with polycarbonate urethane.

Ethylene oxide is introduced into the structure to make the additive uniformly present in polycarbonate urethane. This is considered to be because the ethylene group in ethylene oxide is compatible with the hydrophobic hydrocarbon group in polycarbonate urethane. Propylene oxide is also introduced into the structure to improve the dispersibility of the conductive filler dispersed in the conductive layer. This is considered to be because the side chain methyl group of propylene oxide interacts with the conductive filler to improve the dispersibility of the conductive filler.

R51, which is a monovalent hydrocarbon group having 1 to 12 carbon atoms, is introduced into the structure in order to make the additive uniformly present in polycarbonate urethane. The monovalent hydrocarbon group is compatible with the hydrophobic hydrocarbon group in polycarbonate urethane, and the additive can be uniformly present in polycarbonate urethane. When the number of carbon atoms is 12 or less, steric hindrance with polycarbonate urethane is less likely to occur, and the additive tends to be present uniformly.

Since the compound of formula (5) has a monool structure, the compound has lower reactivity than a diol, is less likely to be incorporated during a urethanization reaction by a reaction between an isocyanate and a polyol, and is less likely to cause a decrease in resistance of the polyurethane due to introduction of an ether structure into polycarbonate urethane.

A polyoxyethylene polyoxypropylene alkyl ether can be obtained by using a commercial product or by synthesis. The polyoxyethylene polyoxypropylene alkyl ether can be synthesized through a step (B) after a step (A) below. The step (B) may be performed on a commercial product having a structure completed up to the step (A).

Step (A): A Reaction of an Alcohol with Ethylene Oxide

Step (B): A Reaction of a Product Obtained in the Step (A) with Propylene Oxide

In the step (A), a reaction can be allowed to proceed by adding ethylene oxide to an alcohol in the presence of a catalyst at 50° C. to 200° C., more preferably 100° C. to 160° C. Since ethylene oxide has a boiling point of 10.7° C. and is a gas at the above temperature, the reaction is preferably performed in an environment pressurized in a sealed container. The pressure is preferably 0.1 to 1.0 MPa. The reaction time is not particularly limited, but is preferably about 1 to 3 hours in order to reduce unreacted ethylene oxide.

As the catalyst, an acid catalyst or an alkali catalyst can be used, but an alkali catalyst is preferable in order to facilitate purification after completion of the reaction. Examples of the alkali catalyst include hydroxides of alkali metals such as sodium hydroxide and potassium hydroxide, hydroxides of alkaline earth metals such as calcium hydroxide and barium hydroxide, ammonium hydroxide, and tertiary amines. In view of ease of reaction and reaction efficiency, sodium hydroxide and potassium hydroxide are particularly preferable. Examples of the acid catalyst include Broensted acids such as sulfuric acid and phosphoric acid, and Lewis acids such as stannous chloride and boron trifluoride.

The amount of the catalyst used is preferably 0.1 to 5 mol % with respect to 1 mol of the alcohol in the case of sodium hydroxide or potassium hydroxide. Ethylene oxide reacts with water to produce ethylene glycol, so that moisture is avoided as much as possible, and if necessary, dehydration treatment may be performed prior to the reaction in the step (A).

The step (B) can be performed under similar conditions to the step (A). The boiling point of propylene oxide is 34.2° C. and is gas at the reaction temperature of 50° C. to 200° C. Therefore, the reaction is preferably performed in an environment pressurized in a sealed container. As the catalyst, the catalyst used in the step (A) may be used as such or a catalyst may be added newly. When a catalyst is added newly, the same catalyst as used in the step (A) is preferable.

Structural formula (6) is a polyetheramine (monoamine) having a structure in which ethylene oxide and propylene oxide are addition-polymerized in a block form. The terminal amino group of this polyetheramine interacts with the surface functional group of the carbon black, which is the conductive filler, by a hydrogen bond, and acts as a dispersing agent for the carbon black. In addition, in order to enhance the effect as the dispersing agent, R61 which is a monovalent hydrocarbon group having 1 to 8 carbon atoms is introduced to form a structure that is easily compatible with the hydrophobic functional group of polycarbonate urethane, and to form a structure that has good compatibility with polycarbonate urethane.

A polyether monoamine can be obtained by using a commercial product or by synthesis. A polyether monoamine can be synthesized through a step (D) after a step (C) below.

Step (C): An Oxidation Reaction of a Compound of Structural Formula (5) which is a Secondary Alcohol

### Step (D): A Reductive Amination Reaction of a Product Obtained in the Step (C)

The step (C) is a reaction to form a ketone in an oxidation reaction of a secondary alcohol. Ketone synthesis by oxidation of a secondary alcohol includes an oxidation reaction using a heavy metal salt such as chromic acid or manganese dioxide and a derivative thereof, and an oxidation reaction of a non-heavy metal salt using dimethyl sulfoxide (DMSO) or a hypohalous acid such as hypochlorous acid.

Synthesis may be performed using any method, but in view of the environmental impact of heavy metals, an oxidation reaction using dimethyl sulfoxide (DMSO) or a hypohalous acid such as hypochlorous acid is preferable. Furthermore, a method using a hypohalous acid is more preferable because dimethyl sulfoxide (DMSO) explosively reacts at room temperature depending on the electrophilic activation reagent used, and a low temperature such as −60° C. is required. Examples of the hypohalous acid include hypochlorites such as sodium hypochlorite and calcium hypochlorite (chlorinated lime). A reaction of such a hypochlorite with a secondary alcohol in acetic acid provides a ketone.

When dimethyl sulfoxide (DMSO) is used, an electrophilic activation reagent is also required. The electrophilic activation reagent increase the electrophilicity of sulfur in dimethyl sulfoxide (DMSO), allowing it to undergo nucleophilic attack by an alcohol hydroxyl group. This nucleophilic attack produces a dimethylalkoxysulfonium salt, which is degraded to give a ketone and a dimethyl sulfide. Examples of the electrophilic activation reagent include dicyclohexylcarbodiimide (DCC), acetic anhydride, phosphorus pentoxide, a sulfur trisulfide-pyridine complex, trifluoroacetic anhydride, oxalyl chloride, and halogen.

The step (D) is a reductive amination reaction that converts a ketone to an amine. The reaction is divided into two stages. First, a carbonyl group reacts with an amine to produce an iminium cation. Subsequently, a hydride reducing agent nucleophilically attacks the iminium cation to produce an amine. As the reducing agent, a borohydride reagent is preferably used. Examples of the borohydride reagent include sodium cyanoborohydride, sodium triacetoxyborohydride, and 2-picoline-borane, and among these, sodium triacetoxyborohydride and 2-picoline-borane, which are less toxic, are preferable. A reductive amination reaction with the borohydride reagent makes it difficult to produce an iminium cation due to steric hindrance if it has a bulky structure. Therefore, R61 in structural formula (6) is preferably a monovalent hydrocarbon group having 1 to 8 carbon atoms.

Structural formula (7) is a polyoxyethylene alkyl ether acetate. The terminal carboxylic acid in structural formula (7) interacts with the surface functional group of the carbon black, which is the conductive filler, by a hydrogen bond, and acts as a dispersing agent for the carbon black. In addition, in order to enhance the effect as the dispersing agent, R71 which is a monovalent hydrocarbon group having 1 to 12 carbon atoms is introduced to form a structure that is easily compatible with the hydrophobic functional group of polycarbonate urethane, and to form a structure that has good compatibility with polycarbonate urethane.

The polyoxyethylene polyoxypropylene alkyl ether acetate can be obtained by using a commercial product or by synthesis. The polyoxyethylene polyoxypropylene alkyl ether acetate can be synthesized through a step (F) after a step (E) below. The step (F) may be performed on a commercial product having a structure completed up to the step (E).

Step (E): a Reaction of an Alcohol with Ethylene Oxide
Step (F): An Oxidation Reaction of a Primary Alcohol being a Product in the Step (E)

The step (E) is the same as the step (A), and preparation can be performed in the same manner as in the step (A).

The step (F) is a step of oxidizing a primary alcohol to produce a carboxylic acid. Oxidation of a primary alcohol requires selection of a method and conditions for a reaction that does not stop with an aldehyde because further oxidation produces a carboxylic acid after an aldehyde is produced. Examples of the method for obtaining a carboxylic acid by oxidation of a primary alcohol include oxidation with an oxidizing agent and a catalytic dehydrogenation reaction with a catalyst. Examples of the oxidizing agent include a permanganate, chromic acid, ruthenium tetroxide, and a hypochlorite. Examples of the catalyst for the dehydrogenation reaction include palladium, platinum, iridium, rhodium, and manganese.

The compounds represented by structural formulae (5) to (7) are compounds having a function as a dispersing agent for the carbon black and high affinity for polycarbonate urethane. A surfactant is usually used as a method for increasing the dispersibility and dispersion stability of the carbon black. However, the compounds represented by structural formulae (5) to (7) have a small number of functional groups acting on the surface functional group of the carbon black, and thus show a weak surfactant effect and are not commonly used. A coupling agent or a nonionic surfactant has been utilized as a common dispersing agent for the carbon black.

As the coupling agent, a silane coupling agent, a titanate coupling agent, and an aluminum coupling agent are used, and as the nonionic surfactant, a polyester or polyether-based nonionic surfactant is used. However, when these dispersing agents are added in the polycarbonate urethane to a level at which the dispersibility of the carbon black is sufficiently enhanced (mass ratio with respect to carbon black: 50 to 100%), the conductivity of the carbon black or the binder resin is inhibited. Conversely, if the amount is at a level not inhibiting the conductivity of the carbon black or the binder resin (mass ratio with respect to carbon black: 10 to 40%), the dispersibility of the carbon black cannot be achieved.

The amount of the compounds represented by structural formulae (5) to (7) added is preferably 3.0 to 7.0 mass % based on the solid content in the conductive layer-forming coating liquid. The amount is more preferably 3.0 to 5.0 mass %. The total content is preferably 18.9 to 46.0 parts by mass with respect to 100 parts by mass of the carbon black in the conductive layer-forming coating liquid.

When the content of the additive in the conductive layer-forming coating liquid is within the above range, the dispersibility of the carbon black into the polyurethane is further improved, and a desired impedance value and surface potential can be more easily achieved.

Checking of the presence of additives in the conductive layer and quantitative evaluation can be analyzed in the following manner. The conductive layer of the developing roller is cut out, and the slice is analyzed using, for example, ¹H-NMR, ¹³CNMR, XPS, and FT-IR. Thereby, the carbonate structure of the binder resin, the ether structure of the additive, the amine structure, and the carboxylic acid structure can be detected in the conductive layer, the ratio can be calculated from the proportions of peaks and the like.

Also, the slice is subjected to extraction by immersion in an organic solvent such as 2-butanone (methyl ethyl ketone; MEK), and the extract and the slice after extraction is analyzed using ¹H-NMR, ¹³C-NMR, XPS, and FT-IR. This makes it possible to calculate the proportions of the additive incorporated and the additive not incorporated during the polymerization reaction of the resin.

The conductive layer may have a structure in which at least one of compounds having structures represented by structural formulae (5) and (6) is bonded to the polyurethane (a structure reacted during polymerization of the polyurethane). The structure reacted during polymerization of the polyurethane includes, for example, the following aspects.
In the case of a structure represented by structural formula (5), a structure in which a compound having a structure represented by structural formula (5) is urethanized in the polyurethane
In the case of a structure represented by structural formula (6), a structure in which a compound having a structure represented by structural formula (6) is urea-converted in the polyurethane

### Coarse Particles

The conductive layer may contain coarse particles. The coarse particles may be, for example, spherical particles. The particle diameter of the coarse particles is, for example, preferably in the range of 1 to 150 μm and more preferably in the range of 5 to 30 μm. For example, at least one spherical particle selected from the following particles is included:

urethane resin particles, acrylic resin particles, phenol resin particles, silicone resin particles, polyacrylonitrile resin particles, polystyrene resin particles, polyurethane resin particles, nylon resin particles, polyethylene resin particles, and polypropylene resin particles. Preferably, the particles are urethane resin particles.

The content of the coarse particles in the conductive layer is preferably 1 to 50 mass %, more preferably 5 to 30 mass %.

### Production Method for Conductive Layer

The method for forming the conductive layer is not particularly limited, but examples thereof may include methods by spraying, dip coating, and roll coating using a coating material. For example, the conductive layer can be formed by applying a conductive layer-forming coating liquid onto a substrate or an elastic layer formed on the outer surface of the substrate by a known method and heating and drying the coating liquid. The conditions for heating and drying are not particularly limited, and examples thereof include a method of drying under conditions at 120° C. to 200° C. The thickness of the conductive layer is also not particularly limited, and is preferably 1 to 50 μm, and more preferably 5 to 20 μm.

### Time Constant of Surface Potential of Conductive Portion

A time constant of the surface potential of the conductive portion of 6.0 seconds or less is preferable because charges injected into the conductive portion are easily removed quickly.

Specifically, in a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, a change in the potential at 0.06≤t≤100.00 is fitted to formula (Y) below by a least squares method to obtain V_{0,2} [V] and τ₂ [sec], τ₂ is preferably 6.0 seconds or less. τ₂ is more preferably 5.0 seconds or less, and still more preferably 4.0 seconds or less. The lower limit is not particularly limited, and the range of τ₂ may be, for example, 0.1 to 6.0 seconds, 0.1 to 5.0 seconds, or 0.1 to 4.0 seconds.

$$V ( t ) = {V}_{1} ( t ) + {V}_{2} ( t ) \qquad ( Y )$$

$$( In formula ( Y ) , {V}_{2} ( t ) = {V}_{0 , 2} exp ( - t / {τ}_{2} ) ( Z ) )$$

As described above, V₁(t) indicates a relaxation curve corresponding to the insulating portion. The change in potential at 0.06≤t≤100.00 also includes the influence of the relaxation curve corresponding to the conductive portion showing fast decay. Therefore, V₂(t) in formula (Y) obtained by fitting the change in potential at 0.06≤t≤100.00 indicates a relaxation curve corresponding to the conductive portion. Therefore, V_{0,2} represents the surface potential of the conductive portion when t=0, and τ₂ represents the time constant of the surface potential of the conductive portion. Detailed measurement conditions for V_{0,2} and τ₂ will be described later.

The time constant of the surface potential of the conductive portion can be controlled by changing the formulation of the binder resin and the conductive filler within a range satisfying the impedance value and the surface potential of the conductive layer.

### First Region (Insulating Portion)

The first region (insulating portion) is placed on the outer surface of the conductive layer. The first region is formed of, for example, an outer surface of an insulator exposed on the outer surface of the conductive layer. The first region may be, for example, present in a dotted pattern on the conductive layer, or may be connected to such an extent that the conductive layer (second region) is exposed.

When a square observation region having a side length of 300 μm is placed on the outer surface of the developing roller such that the axial direction of the developing roller and one side of the observation region are parallel to each other, the proportion of the total area of the first region to the area of the square observation region is preferably 10 to 60 area %, more preferably 15 to 50 area %, and still more preferably 20 to 40 area % from the viewpoint of applying an appropriate gradient force to the developing roller.

The ratio of the total area of the first region can be controlled by the wettability of a constituent material solution of the first region, the viscosity of the solution, the drying speed, the surface roughness of the conductive layer, the solid content of the solution, and the like.

The height of each insulating portion from a contact portion with the conductive layer is preferably 0.1 to 10.0 μm. By setting this height to 0.1 μm or more, the toner is easily attracted when the first region is charged. Further, by setting the height to 10.0 μm or less, the toner is easily charged between the first region and the contact member.

The ratio of the total area and the height of this first region can be measured using, for example, a laser microscope (trade name: VK-X100, manufactured by KEYENCE CORPORATION). This will be specifically described later.

### Surface Potential of Insulating Portion

A time constant (τ₁) of the surface potential of the insulating portion of 60.0 seconds or more is preferable because charges injected into the insulating portion are less likely to be removed and the insulating portion can be charged quickly. Since the insulating portion is quickly charged, a potential difference between the insulating portion and the conductive portion becomes clear from the start of printing, and a toner transporting force is easily exhibited.

τ₁ is more preferably 100.0 seconds or more, still more preferably 1000.0 seconds or more. The upper limit of τ₁ is not particularly limited, and the range of τ₁ may be 60.0 to 5000.0 seconds, 100.0 to 4500.0 seconds, or 1000.0 to 4000.0 seconds.

As described above, the time constant of the surface potential of the insulating portion is obtained by fitting the change in the potential at 30.00≤t≤100.00 seconds in the measurement of the change in the surface potential of the developing roller to formula (X′) below by a least squares method.

$${V}_{1} ( t ) = {V}_{0 , 1} exp ( - t / {τ}_{1} ) \qquad ( {X}^{′} )$$

Detailed measurement conditions will be described later.

In a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of a width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, a change in the potential at 30.00≤t≤100.00 is fitted to the above formula (X′) by a least squares method to obtain V_{0,1} [V] and τ₁ [sec], when a value of a potential V₁(t) at the time of substituting t=0.06 [sec] into formula (X′) is denoted by V₁ [V], V₁ is preferably 5.0 V or more.

When the surface potential immediately after charging is performed by the corona discharger is 5.0 V or more, a gradient force necessary for transporting the toner is easily exhibited when charges are injected into the insulating portion. V₁ is more preferably 6.0 V or more, still more preferably 10.0 V or more. The upper limit of V₁ is not particularly limited, and the range of V₁ may be 5.0 to 35.0 V, 6.0 to 33.0 V, or 10.0 to 20.0 V.

In order to obtain τ₁ and V₁ as described above, the volume resistivity of the insulating portion is preferably from 1.0×10¹³ Ω·cm to 1.0×10⁸ Ω·cm, and more preferably from 1.0×10¹⁴ Ω·cm to 1.0×10¹⁷ Ω·cm.

The volume resistivity of the insulating portion can be adjusted, for example, by using the following materials or adjusting the amount thereof.

### Material Forming Insulating Portion

Various electrically insulating materials can be used as the material forming the insulating portion. Further, the material is preferably a material which is relatively hard to break when it is deformed by contact of the developing member with other members. Specific examples thereof include metal oxides such as silicon dioxide and aluminum oxide, and inorganic materials such as diamond. In addition, examples thereof include resins such as polyethylene, polystyrene, a polycarbonate, a polyacrylic, polytetrafluoroethylene, a phenol resin, a urea resin, a silicone resin, and a polyimide resin. Resins such as polystyrene, a polycarbonate, a polyacrylic, polytetrafluoroethylene, a silicone resin, and a polyimide resin, and copolymers of these resins are particularly preferable because they have high electric resistance, are hard to break even by some deformation, and are resistant to rubbing. Among them, a polycarbonate is preferable. Accordingly, it is preferable that the first region contains at least one type of polycarbonate.

In particular, it is preferable that the insulating portion contains a polycarbonate having the following specific structure because charges are easily injected into the toner, and fogging is easily improved even immediately after printing a high-density image. That is, at least one type of polycarbonate preferably has a structure represented by structural formula (8) below.

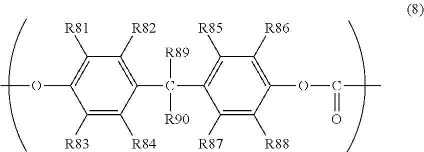

In structural formula (8), R81 to R88 are each independently a hydrogen atom, an alkyl group having 1 to 9 (preferably 1 to 4, more preferably 1 to 3) carbon atoms, or an aryl group having 6 to 10 (preferably 6 to 8, more preferably 6) carbon atoms.

R89 and R90 each independently represent a hydrogen atom, an alkyl group having 1 to 9 (preferably 1 to 4, more preferably 1 to 3) carbon atoms, or an aryl group having 6 to 10 (preferably 6 to 8, more preferably 6) carbon atoms, or R89 and R90 are a group of atoms necessary for R89 and R90 to be bonded to each other to form an alicyclic structure having 6 to 12 carbon atoms.

However, structural formula (8) satisfies at least one condition selected from the group consisting of Condition 1 and Condition 2 below:

### Condition 1

At least one (preferably 1 to 4, more preferably 1 to 3, still more preferably 2) selected from the group consisting of R81 to R88 is an alkyl group having 1 to 9 (preferably 1 to 4, more preferably 1 to 3) carbon atoms or an aryl group having 6 to 10 (preferably 6 to 8, more preferably 6) carbon atoms. Preferably, the remainders of R81 to R88 are hydrogen atoms.

### Condition 2

At least one selected from the group consisting of R89 and R90 is a linear or branched alkyl group having 2 or more (preferably 2 to 10, more preferably 3 to 6) carbon atoms or an aryl group having 6 to 10 (preferably 6 to 8, more preferably 6) carbon atoms. One of R89 and R90 preferably satisfies the above condition, and the other is preferably an alkyl group having 1 to 3 (preferably 1) carbon atoms.

When the drive torque between the toner supply roller and the developing roller is reduced, the charge amount of the toner given there is also likely to be reduced because rubbing between the toner supply roller and the developing roller is reduced. When the toner on the developing roller is repeatedly rubbed with the rotation of the developing roller, the influence is slight. On the other hand, when a high-density image is printed, most of the toner on the developing roller is consumed to the photosensitive drum, so that most of the toner on the developing roller becomes a newly supplied toner which is not much subjected to rubbing. Therefore, the toner on the developing roller immediately after printing a high-density image is likely to be insufficiently charged, and fogging may increase.

The structure of the polycarbonate of structural formula (8) has steric hindrance in the aromatic rings of the main chain, has lower molecular orientation and higher molecular mobility than those of a general polycarbonate. By providing steric hindrance around the aromatic ring, there is a portion having high molecular mobility such as steric hindrance around the aromatic ring with respect to a conventional polycarbonate. Therefore, when exposed to an external electric field, micromolecular orientation is generated in a part thereof, and the dielectric constant increases. That is, when passing through the developing blade nip to which the developing blade bias is applied, the dielectric constant of the insulating portion increases. Therefore, the toner sandwiched between the developing blade and the insulating portion is likely to be subjected to charge transfer by the electric field. At this time, since the conductive layer of the present disclosure prevents charge leakage from the insulating portion to the conductive layer, as a result, charges are easily injected not only into the insulating portion but also into the toner. As a result, the toner is easily charged quickly when passing through the developing blade, and thus, fogging immediately after printing a high-density image is further prevented.

In addition, since the polycarbonate has low molecular orientation, the dielectric constant is low when the polycarbonate is not exposed to an external electric field, and the potential increases during charging, so that the toner transporting force is easily obtained, and thus the polycarbonate is suitable as the material of the insulating portion.

Hereinafter, a more preferable polycarbonate will be described. Examples of the polycarbonate include a polycarbonate in which at least one of R81 and R83 is an alkyl group having 1 to 9 carbon atoms or an aryl group having 6 to 10 carbon atoms, and at least one of R86 and R88 is an alkyl group having 1 to 9 carbon atoms or an aryl group having 6 to 10 carbon atoms in structural formula (8), and a polycarbonate in which at least one selected from the group consisting of R89 and R90 is a linear or branched alkyl group having 2 or more carbon atoms or an aryl group having 6 to 10 carbon atoms in structural formula (8). Specifically, the polycarbonate preferably contains at least one selected from the group consisting of structural formulae (9) to (11) below.

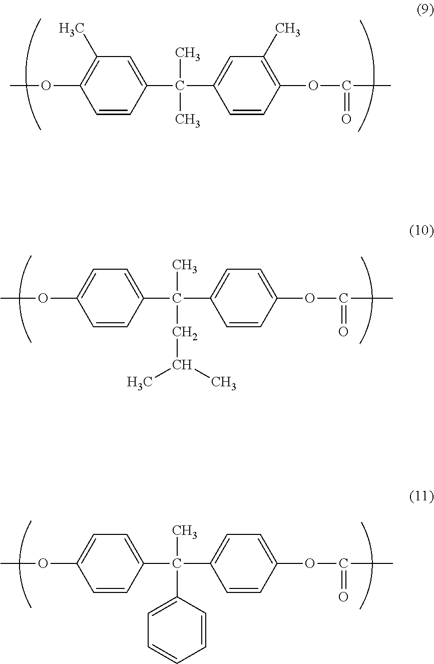

When the polycarbonate contains at least one selected from the group consisting of structural formulae (9) to (11), the micromolecular orientation when exposed to an external electric field tends to be enhanced. In addition, it is more preferable that at least one type of polycarbonate has a structure represented by structural formula (9).

It is preferable that the at least one type of polycarbonate has at least one structure selected from the group consisting of a structure represented by structural formula (10) and a structure represented by structural formula (11). With this structure, the adhesion force of the aromatic ring can be further loosened, and the micromolecular orientation can be enhanced.

Hereinafter, a method of synthesizing the polycarbonate will be described. For example, two methods will be described below. The first method is a method of allowing one type of bisphenol compound to react directly with phosgene (phosgene method). The second method is a method of subjecting a bisphenol compound to a transesterification reaction with bisallyl carbonate such as diphenyl carbonate, di-p-tolyl carbonate, phenyl-p-tolyl carbonate, di-p-chlorophenyl carbonate, or dinaphthyl carbonate (transesterification method).

In the phosgene method, a bisphenol compound is allowed to react with phosgene typically in the presence of an acid linker and a solvent. Examples of the acid linker used at this time include pyridine and hydroxides of alkali metals such as potassium hydroxide and sodium hydroxide. Also, examples of the solvent include methylene chloride and chloroform. Furthermore, a catalyst or a molecular weight modifier may be added to promote a condensation polymerization reaction. Examples of the catalyst include tertiary amines such as triethylamine and quaternary ammonium salts. Examples of the molecular weight modifier include monofunctional group compounds such as phenol, p-cumylphenol, t-butylphenol, and a long-chain alkyl-substituted phenol.

Further, when the polycarbonate is synthesized, an antioxidant such as sodium sulfite or hydrosulfite; or a branching agent such as phloroglucin or isatin bisphenol may be used. The reaction temperature at the time of synthesizing the polycarbonate is preferably 0 to 150° C., and more preferably 5 to 40° C. The reaction time depends on the reaction temperature, but is usually preferably 0.5 minutes to 10 hours, and more preferably 1 minute to 2 hours. During the reaction, the pH of the reaction system is preferably 10 or more.

The chemical structure of the resin can be specified through NMR analysis.

The weight-average molecular weight (Mw) of the polycarbonate is preferably from 1,000 to 500,000. Usually, as the weight-average molecular weight of the polycarbonate decreases, the insulating portions are more likely to gather together when the insulating portions are formed on the conductive layer, and thus are more likely to have a bowl shape with a relatively high height. Furthermore, as the weight-average molecular weight of the polycarbonate increases, the polycarbonate is more likely to spread over the conductive layer and is more likely to have a branched shape with a low height. Therefore, the weight-average molecular weight of the polycarbonate within the above range is preferable because the insulating portion covering a part of the conductive layer is easily formed.

The weight-average molecular weight of the resin can be measured by gel permeation chromatography (GPC).

### Method for Forming First Region

The method for forming the first region to be the insulating portion is not particularly limited, but for example, the following methods can be used. That is, there is a method in which an insulating portion-forming coating liquid prepared by diluting an insulating material with a solvent is applied in an island shape onto the conductive layer by screen printing, a jet dispenser, or the like, and then solidified by drying the solvent. Further, there is a method in which an insulating portion-forming coating liquid is uniformly applied onto the conductive layer by dipping or the like, repelled so that the conductive layer is exposed by controlling wettability, and then solidified by drying the solvent. Further, there is a method in which an insulating portion-forming coating liquid containing a raw material of an insulating material is applied in an island shape onto the conductive layer by screen printing, a jet dispenser, or the like, and then the raw material of the insulating material is cured by heating, ultraviolet irradiation, or the like as necessary. In addition, there is a method in which an insulating portion-forming coating liquid containing a raw material of an insulating material is uniformly applied onto the conductive layer by dipping or the like, repelled so that the conductive layer is exposed by controlling wettability, and then the raw material of the insulating material is cured by heating, ultraviolet irradiation, or the like as necessary.

As the method of controlling the wettability, for example, a method of adding a surface adjusting agent to the conductive layer can be used.

### Elastic Layer

The developing roller may have an elastic layer on the outer surface of the substrate. The developing roller includes, for example, an elastic layer between the substrate and the conductive layer. The elastic layer is not particularly limited, and a known elastic layer may be used as the elastic layer of the developing roller. Examples thereof include a cured product of an addition cure-type liquid silicone rubber mixture.

### Process Cartridge and Electrophotographic Image Forming Apparatus

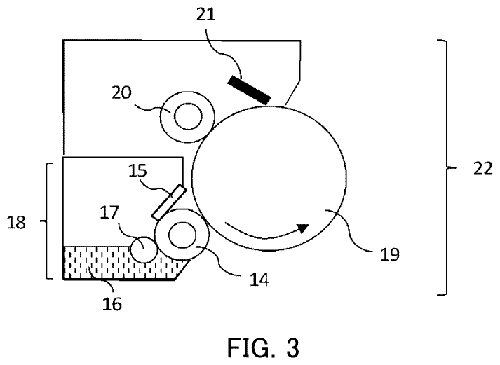

The developing roller of the present disclosure can be suitably used as a developing roller in a process cartridge. FIG. 3 is a schematic sectional view of an example of the process cartridge according to one aspect of the present disclosure. A process cartridge 22 is configured to be attachable and detachable to the main body of the electrophotographic image forming apparatus. The process cartridge 22 includes a developing apparatus 18 provided with a developing roller 14 and a developing blade 15, a photosensitive member 19; a charging roller 20, and a cleaning blade 21, which are integrated together. That is, the process cartridge includes a developing unit, and the developing unit includes the developing roller 14. The developing apparatus 18 is further filled with a toner 16. The toner 16 is supplied to the surface of the developing roller 14 by the toner supply roller 17, and a layer of the toner 16 having a predetermined thickness is formed on the surface of the developing roller 14 by the developing blade 15.

The developing roller 14 is in contact with the photosensitive member 19 and is driven to rotate at a predetermined peripheral speed ratio with respect to the photosensitive member 19. A predetermined bias is applied to the developing roller 14 to develop and visualize the electrostatic latent image on the photosensitive member 19 using the toner 16.

The toner supply roller 17 is in contact with the developing roller 14, penetrates in a predetermined penetration level, and rotates in the same direction as or reverse direction to the rotational direction of the developing roller 14. Further, a predetermined bias may be applied to the toner supply roller 17. By reducing the difference in relative speed between the toner supply roller 17 and the developing roller 14 or by reducing the penetration level for the developing roller 14 of the toner supply roller 17, the drive torque can be significantly reduced.

One end of the developing blade 15 is fixed to the developing apparatus 18, and the other free end is disposed in contact with the developing roller 14 in a counter direction to the rotational direction of the developing roller 14. By disposing the developing blade 15 in contact with the developing roller 14, the amount of the toner on the developing roller 14 is regulated and made thin to form a toner layer having a uniform thickness. A predetermined bias is applied to the developing blade 15, and charges are applied to the toner 16 and the insulating portion on the outer surface of the developing roller 14.

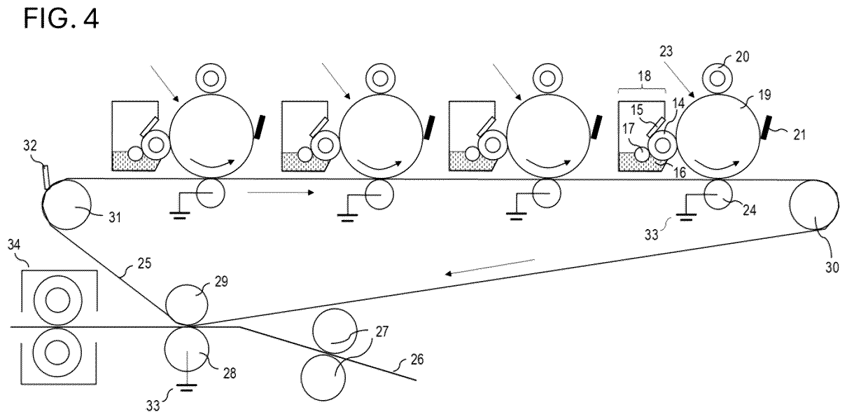

FIG. 4 is a schematic cross-sectional view showing an example of an electrophotographic image forming apparatus including a contact-type developing apparatus using a one-component toner.

The developing apparatus 18 includes a toner 16 as one-component toner, a developing roller 14, a toner supply roller 17 that supplies the toner to the developing roller 14, and a developing blade 15 for regulating the thickness of the toner layer on the developing roller 14. That is, the electrophotographic image forming apparatus includes a developing unit, and the developing unit includes the developing roller 14. The developing roller 14 is located in an opening in the developing apparatus 18 extending in the longitudinal direction and is installed in contact with the photosensitive member 19. The photosensitive member 19, the charging roller 20, and the cleaning blade 21 may be disposed in the main body of the electrophotographic image forming apparatus. The developing apparatus 18 is provided with respective color toners of black, cyan, magenta, and yellow, which makes it possible to perform color printing.

The printing operation of the electrophotographic image forming apparatus will be described below. The photosensitive member 19 rotates in the direction of the arrow and is uniformly charged by the charging roller 20 for charging the photosensitive member 19. Next, an electrostatic latent image is formed on the surface of the photosensitive member 19 by a laser light 23, which is an exposure unit. The electrostatic latent image is visualized (developed) as a toner image by applying the toner 16 from the developing roller 14 disposed in contact with the photosensitive member 19 by the developing apparatus 18. The development is so-called reversal development for forming a toner image on an exposed portion.

The toner image formed on the photosensitive member 19 is transferred to an endless belt-shaped intermediate transfer member 25 by a transfer roller 24 that is a transfer member.

A paper sheet 26, which is a recording medium, is fed into the apparatus by a paper feed roller 27 and a secondary transfer roller 28, and is transported to a nip portion between the secondary transfer roller 28 and a driven roller 29 together with the intermediate transfer member 25 having the toner image, and the toner image is transferred to the paper sheet 26. The intermediate transfer member 25 is operated by the driven roller 29, a driver roller 30, and a tension roller 31. The toner remaining on the intermediate transfer member 25 is cleaned by a cleaning apparatus 32.

A voltage is applied from a bias power source 33 to the developing roller 14, the developing blade 15, the transfer roller 24, and the secondary transfer roller 28. The paper sheet 26 to which the toner image is transferred is subjected to fixing by a fixing apparatus 34 and ejected to the outside of the apparatus, and the printing operation is finished. Meanwhile, the transfer residual toner remaining on the photosensitive member 19 without being transferred is scraped off by a cleaning blade 21, which is a cleaning member for cleaning the surface of the photosensitive member. The cleaned photosensitive member 19 repeats the above printing operation.

### Impedance

In the impedance measurement, the response of the developing roller when an AC voltage and a DC voltage are applied is examined while changing the frequency. An AC voltage is applied and measured separately into two of a response without a phase shift and a response with a phase shift of π/2 with respect to the applied AC voltage, plotted as a complex plane with the impedance of the response without a phase shift as Z′ (real part) and the impedance of the response with a phase shift as Z″ (imaginary part), and a distance from the origin to the plot is calculated as an impedance value.

When the electrical characteristics of the developing roller are pseudo-represented by an RC parallel circuit, the real part without a phase shift indicates a resistance component, and the imaginary part with a phase shift indicates an electrostatic capacitance component. Note that the meanings of the measurement conditions and measurement values have been described in Technical Significance of Requirement (1) mentioned above, and thus are omitted in this section.

The impedance measuring method, measuring apparatus, and measurement conditions will be described below.

### Impedance Measuring Method

The impedance of the developing roller can be measured by the following methods (1) and (2).
(1) A method in which a thin film electrode is provided on a surface of a developing roller, and measurement is performed using two terminals of the electrode and the substrate.
(2) A method in which a developing roller is pressed against a metal drum with a constant load, and measurement is performed using two terminals of the metal drum and the substrate.

Although the impedance can be measured by any method, the method (2) is affected by the width of the nip and the contact area between the developing roller and the metal drum, and thus it is necessary to measure the impedance with the developing roller having an equivalent hardness. Therefore, in the present disclosure, measurement is performed by the method (1). Hereinafter, the measurement method (1) will be described, and more specific conditions will be described later.

In the measurement of the impedance, in order to eliminate the influence of the contact resistance between the developing roller and the measuring electrode, it is preferable to deposit a low-resistance thin film on the surface of the developing roller and measure the impedance with two terminals using the thin film as an electrode and a conductive substrate as a ground electrode.

Examples of a method for forming the thin film include a method for forming a metal film such as metal vapor deposition, sputtering, application of a metal paste, and attachment of a metal tape. Among them, from the viewpoint of reducing the contact resistance with the developing roller, a method for forming a metal thin film of, for example, platinum or palladium as an electrode by vapor deposition is preferable. Vacuum platinum vapor deposition is adopted in the present disclosure.

When the metal thin film is formed on the surface of the developing roller, it is preferable to use a vacuum vapor deposition apparatus in which a mechanism capable of holding the developing roller is provided to the vacuum vapor deposition apparatus and a rotation mechanism is further provided to the developing roller having a cylindrical cross section in consideration of simplicity and uniformity of the thin film.

It is preferable that a metal thin film electrode having a width of about 10 mm in the longitudinal direction of the developing roller is formed, and a metal sheet wound around the metal thin film electrode in a direction intersecting the longitudinal direction without a gap is connected to a measuring electrode coming out of a measuring apparatus to perform measurement. In the case of a cylindrical developing roller, it is preferable to use a metal sheet wound without a gap in the circumferential direction of the developing roller. As a result, the impedance measurement can be performed without being affected by the fluctuation of the size of the outer edge (the outer diameter in the case of a cylindrical developing roller) in the cross section orthogonal to the longitudinal direction of the developing roller or the surface profile. As the metal sheet, an aluminum foil, a metal tape or the like can be used.

### Impedance Measurement Conditions

The impedance measuring apparatus may be any apparatus capable of measuring an impedance in a frequency range of up to 1.0×10⁻¹ to 1.0×10⁵ Hz, such as an impedance analyzer, a network analyzer, or a spectrum analyzer. Among them, it is preferable to perform measurement with an impedance analyzer from the viewpoint of the electric resistance range of the developing roller.

The impedance measurement conditions will be described. The impedance in the frequency range of 1.0×10⁻¹ to 1.0×10⁵ Hz is measured using an impedance measuring apparatus. As the measurement environment, the temperature is 23° C. and the relative humidity is 50%. The impedance measurement point is a central portion in the longitudinal direction of the developing roller. The voltage application condition is that an AC voltage of 50 V is superposed on a DC voltage of 50 V.

More details are as follows.

First, as a pretreatment, vacuum platinum vapor deposition is performed on a developing roller while rotating to prepare a measuring electrode. In the vapor deposition, a vacuum vapor deposition apparatus having a mechanism for holding a base portion of a roller as an object to be coated and rotating the base portion in a circumferential direction is used, and vapor deposition is performed so that the film thickness is 100 nm or more by controlling the roller rotation speed, vapor deposition distance, and vapor deposition time. At this time, a masking tape is used to form an electrode with a width of 1.5 cm. By forming the electrode with a film thickness of 100 nm or more, the contribution of the contact area between the measuring electrode and the developing roller can be reduced as much as possible by the surface roughness of the developing roller.

Next, an aluminum sheet is wound around the electrode without any gap, and the aluminum sheet is connected to the measuring electrode of an impedance measuring apparatus (trade name: Solartron 1260 and Solartron 1296, manufactured by Solartron, Inc.) and a high voltage system (trade name: 6792 and HVA-500, manufactured by TOYO Corporation).

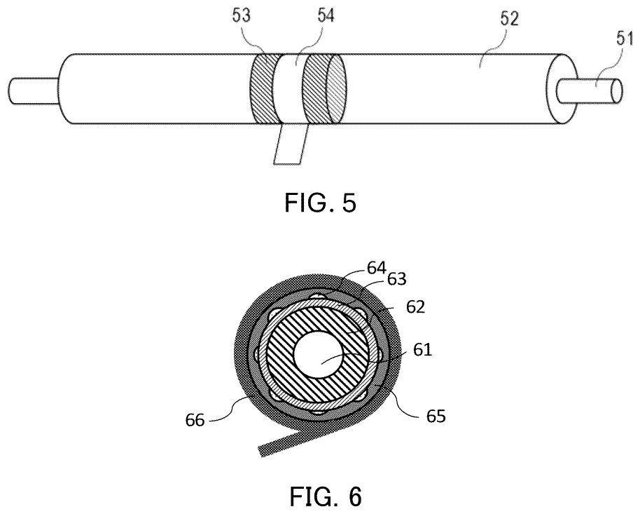

FIG. 5 shows a schematic view of a state in which the measuring electrode is formed on the developing roller. In FIG. 5, reference numeral 51 denotes a conductive substrate, reference numeral 52 denotes a conductive layer, reference numeral 53 denotes a platinum vapor deposition layer, and reference numeral 54 denotes an aluminum sheet. Although not shown in the figure, the elastic layer is present between the substrate 51 and the conductive layer 52.

FIG. 6 shows a cross-sectional view of a state in which the measuring electrode is formed on the developing roller. Reference numeral 61 denotes a conductive substrate, reference numeral 62 denotes an elastic layer, reference numeral 63 denotes a conductive layer, reference numeral 64 denotes an insulating portion, reference numeral 65 denotes a platinum vapor deposition layer, and reference numeral 66 denotes an aluminum sheet. As shown in FIG. 6, it is important to sandwich the conductive layer between the conductive substrate and the measuring electrode.

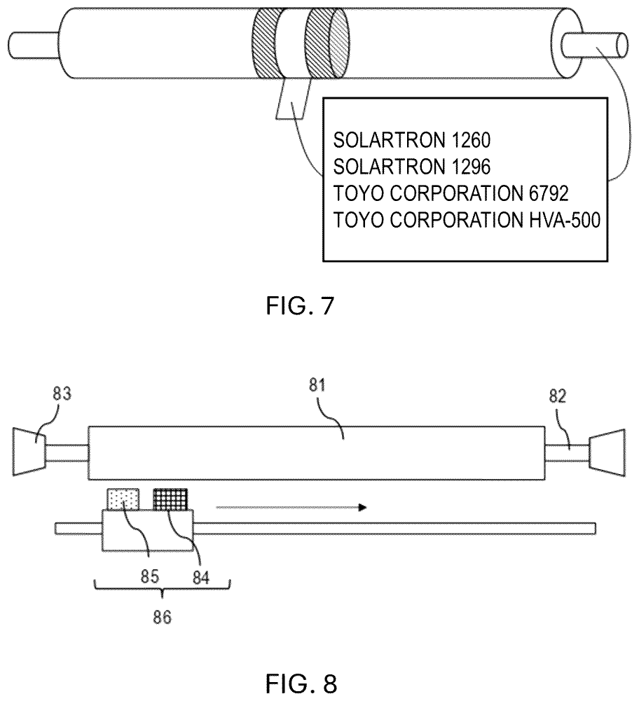

Then, the aluminum sheet is connected to the measuring electrode on a side of an impedance measuring apparatus (trade name: Solartron 1260 and Solartron 1296, manufactured by Solartron, Inc.) and a high voltage system (trade name: 6792 and HVA-500, manufactured by TOYO Corporation). FIG. 7 shows a schematic view of the measurement system. Impedance measurement is performed by using the conductive substrate and the aluminum sheet as two electrodes for measurement.

In the impedance measurement, a DC voltage of 50 V and an AC voltage of 50 V are applied in an environment at a temperature of 23° C. and a relative humidity of 50%, and an absolute value of an impedance is obtained at a frequency of 1.0×10⁻¹ to 1.0×10⁵ Hz. Then, the minimum value of the impedance value at a frequency of 1.0×10⁰ to 1.0×10¹ Hz is checked. The impedance measurement point is a central portion in the longitudinal direction of the developing roller.

### Measurement of Surface Potential

A corona discharger having a grid portion with a width of 3.0 mm is placed in an environment at a temperature of 23° C. and a relative humidity of 50% such that a distance between the grid portion and an outer surface of the developing roller is 1.0 mm and a width direction of the grid portion is aligned with an axial direction of the developing roller. A voltage of 8 kV is applied to the grid portion, and the corona discharger is relatively moved along the axial direction of the developing roller at a speed of 400 mm/sec to charge the outer surface of the developing roller. The corona discharger is stopped at the measuring position on the developing roller, and the change in the surface potential of the developing roller at 0.06 seconds to 100.00 seconds after passage of the grid portion is measured at 0.01 second intervals.

When the time after passage of the grid portion is denoted by t (sec), the surface potential at t=0.06 is denoted by V_{INI}. Furthermore, the measurement results at 30.00≤t≤100.00 are fitted to formula (X′) below by a least squares method to calculate V_{0,1} and τ₁.

$${V}_{1} ( t ) = {V}_{0 , 1} exp ( - t / {τ}_{1} ) \qquad ( {X}^{′} )$$

Further, V_{INI}−V₁ is calculated from V₁ that is a value when t=0.06 [sec] is substituted into the above formula.

In addition, the measurement results at 0.06≤t≤100.00 are fitted to formula (Y) below by a least squares method to calculate V_{0,2} [V] and τ₂.

$$V ( t ) = {V}_{1} ( t ) + {V}_{2} ( t ) \qquad ( Y )$$

$$In formula ( Y ) , {V}_{2} ( t ) = {V}_{0 , 2} exp ( - t / {τ}_{2} ) \qquad ( Z )$$

The measurement is performed at 9 points in total, 3 points in the longitudinal direction×3 points in the circumferential direction of the developing roller, and the arithmetic means thereof are defined as V_{INI}−V₁, τ₁, and τ₂ of the developing roller.

The surface potential of the developing roller can be measured by the apparatus shown in FIG. 8, for example. Both end portions of a substrate 82 of a developing roller 81 are held by a chuck 83, and a measuring unit 86 in which a corona discharger 84 and a surface electrometer 85 are disposed in parallel at an interval of 25 mm is disposed facing the surface of the developing roller 81 at an interval of 1.0 mm distance. In a state where the developing roller 81 is stationary, a voltage of 8 kV is applied to the grid portion of the corona discharger 84, the measuring unit 86 is moved in the axial direction of the developing roller 81 at a speed of 400 mm/sec, and a change in the surface potential of the developing roller at 0.06 seconds to 100.00 seconds after passage of the corona discharger 84 is measured at 0.01 second intervals using the surface electrometer 85.

The meanings of the measurement conditions and measurement values have been described in Technical Significance of Requirement (2) mentioned above, and thus are omitted in this section.

More details are as follows.

The surface potential of the developing roller is measured using a charge amount measuring apparatus (trade name: DRA-2000L, manufactured by Quality Engineering Associates, Inc.). Specifically, a corona discharger having a grid portion is placed in an environment at a temperature of 23° C. and a relative humidity of 50% such that a distance between the grid portion and an outer surface of the developing roller is 1.0 mm and a width direction of the grid portion is aligned with an axial direction of the developing roller. The grid portion of the corona discharger of the apparatus has a width of 3.0 mm.

Subsequently, a voltage of 8 kV is applied to the corona discharger, and the corona discharger is relatively moved along the axial direction of the developing roller at a speed of 400 mm/sec to charge the outer surface of the conductive member. The surface potential of the developing roller at 0.06 seconds to 100.00 seconds after passage of the grid portion is measured at 0.01 second intervals.

Calculation of Physical Properties Such as Circle-Equivalent Diameter and Inter-Wall Distance of Carbon Black Dispersed in Conductive Layer

The dispersed particle diameter and inter-wall distance of the carbon black dispersed in the conductive layer are measured by the following method.

First, a slice (with a thickness of 0.5 to 1.0 mm) is cut out using a razor so that a cross section perpendicular to the longitudinal direction of the developing roller can be observed. If the adhesiveness between the substrate and the conductive layer is high, and it is difficult to cut out a slice with a razor, the entire substrate is cut out with a metal saw or the like, and then cross-sectional processing is performed with a focused ion beam (FIB) apparatus.

The slice is then platinum-deposited, and a scanning electron microscope (SEM) (trade name: JSM-7800F, manufactured by JEOL Ltd.) is used to take an image of the conductive layer at 15,000× to obtain a cross-sectional image.

Furthermore, in order to quantify the cross-sectional image obtained by SEM observation, 8-bit gray scaling is performed on the cross-sectional image using image processing software (trade name: Luzex AP, manufactured by NIRECO Corporation) to obtain a 256-gradation monochrome image. Subsequently, black and white of the image are reversed so that the carbon black in the cross-sectional image becomes white, and then a threshold for binarization is set on the basis of the algorithm of Otsu's discriminant analysis method for the brightness distribution of the image to obtain a binarized image in which the carbon black is white, and the binder resin portion is black.

Then, the circle-equivalent diameter and the adjacent inter-wall distance of the white carbon black portions in the obtained binarized image are calculated using image processing software (trade name: Luzex AP, manufactured by NIRECO Corporation). The image region for calculating the circle-equivalent diameter and the adjacent inter-wall distance is set to a region inside 0.075 μm (If there is a text section describing SEM measurement conditions or the like, 0.075 μm inside from the part where the actual image started) in the actual image dimensions to eliminate uncertainty in the calculated values of the carbon black that is divided at the top, bottom, left and right edges of the image, and the circle-equivalent diameter and the adjacent inter-wall distance for all the carbon black in the designated image region are calculated.

Then, an arithmetic mean and a standard deviation are calculated for the distribution of the obtained circle-equivalent diameter and adjacent inter-wall distance. The number of sheets of images to be analyzed may be one, but at least three or more sheets of images may be analyzed in order to eliminate the influence of the differences in positions in the longitudinal direction of the carbon black dispersed in the conductive layer of the developing roller.

The number average diameter of primary particles of the carbon black dispersed in the resin is measured with a transmission electron microscope (TEM). First, a sliced sample is prepared. A known method can be used for forming a thin slice. For example, a sample can be sliced with an ion beam, a diamond knife, or the like. In the present disclosure, a 40 nm-thick sliced sample for observation is prepared using an ultramicrotome (trade name: ULTRACUT-S, manufactured by Leica Microsystems, Inc.).

Then, a TEM image is acquired using a transmission electron microscope (trade name: H-7100FA, manufactured by Hitachi High-Tech Co., Ltd.) under measurement conditions of a TE mode and an acceleration voltage of 100 kV.

Then, with respect to the obtained TEM image, the circle-equivalent diameters of 50 primary particles of the carbon black in the TEM image are measured using image analysis software (trade name: WinROOF, manufactured by MITANI CORPORATION), and the number average value of the 50 primary particles is defined as the number average diameter of the primary particles.

### Checking of First Region and Second Region

The outer surface of the developing roller is observed using a laser microscope (trade name: VK-X100, manufactured by KEYENCE CORPORATION) with an objective lens of 20 times. On the roller surface, the first region that is repelled in an island shape and the second region that is exposed on the surface of the conductive layer can be checked.

### Proportion of Total Area of First Region

An objective lens with a magnification of 20 times is installed on a laser microscope (trade name: VK-X100, manufactured by KEYENCE CORPORATION). Then, an image of the surface of the developing roller is taken in 9 regions in total, two locations at 10 mm inward from both end portions in the longitudinal direction, one location at the center, and three locations in the circumferential direction (at intervals of 120°).

Next, it is assumed that the axial direction of the developing roller and the observation image are parallel by performing tilt correction of the obtained observation image in a quadratic curved surface correction mode. At the center of the corrected image, the total area occupied by the first region in a square area with a side length of 300 μm is measured. A value obtained by dividing the total area occupied by the first region within the square area with a side length of 300 μm is defined as the proportion of the total area of the first region. The arithmetic mean of the proportion of the total area obtained in the 9 regions is obtained and defined as the proportion of the total area of the first region of the developing roller.

### Measurement of Resistance of First Region

A sample including the first region is cut out from the developing roller, and a slice sample with a plane size of 50 μm square and a thickness t of 100 nm is prepared by a microtome. Next, this slice sample is placed on a metal flat plate, and the slice sample is pressed with a metal terminal having a pressing surface with an area S of 100 μm² from the upper side. In this state, a voltage of 1 V is applied between the metal terminal and the metal flat plate with an electrometer 6517B (trade name, manufactured by KEITHLEY) to obtain a resistance R. A volume resistivity pv (Ω·cm) is calculated from the resistance R using the following formula.

$$p v = R \times S / t$$

### Measurement of DBP Absorption Amount of Carbon Black

The DBP absorption amount of the carbon black is measured according to the Japanese Industrial Standards (JIS) K 6217-4 on the powder of the carbon black.

### Measurement of pH of Carbon Black

The pH of the carbon black is measured according to ASTM D1512 on the powder of the carbon black.

### Examples

The present disclosure will be described in further detail below by way of examples, which are not limiting the present disclosure at all.

### Production Examples of Developing Roller

Although this example describes a developing roller in which a conductive layer is laminated on an elastic roller provided with an elastic layer on an outer surface of a substrate, and further an insulating portion is placed, but the developing roller is not limited to this configuration.

### 1. PREPARATION OF RAW MATERIALS FOR FORMING CONDUCTIVE LAYER, AND PRODUCTION

### 1-1. Preparation of Raw Polyol and Production Example

Hereinafter, a synthesis example for obtaining a polyurethane resin layer will be described.

### Measurement of Number Average Molecular Weight of Raw Polyol

The apparatus used to measure the number average molecular weight (Mn) in the present production example, and conditions are as follows.
Measuring apparatus: HLC-8120 GPC (manufactured by Tosoh Corporation)
Column: TSKgel Super HZMM (manufactured by Tosoh Corporation)×2
Solvent: Tetrahydrofuran (THF) (20 mmol/l triethylamine added)
Temperature: 40° C.
Frow rate of THF: 0.6 ml/min

As the measuring sample, 0.1 mass % THF solutions were used. Furthermore, measurement was performed using an RI (refraction index) detector as a detector.

Calibration curves were prepared using TSK standard polystyrene A-1000, A-2500, A-5000, F-1, F-2, F-4, F-10, F-20, F-40, F-80, and F-128 manufactured by Tosoh Corporation as standard samples for preparing a calibration curve. On the basis of this calibration curve, the number average molecular weight was determined from the retention time of the obtained measuring sample.

### Preparation of Raw Polyol

Commercial products were used for A-1 to A-5, which are 5 types of raw polyols shown in Table 1 below. Also, raw polyols A-6 and A-7 were synthesized by the following method.

TABLE 1

| No. | Raw polyol |
|---|---|
| A-1 | Duranol T5652 Mn = 2000 |
| | (Manufactured by Asahi Kasei Chemicals Corporation) |
| A-2 | Duranol G3452 Mn = 2000 |
| | (Manufactured by Asahi Kasel Chemicals Corporation) |
| A-3 | ETERNACOLL UH-200 Mn = 2000 |
| | (Manufactured by Ube Industries, Ltd.) |
| A-4 | Nippolan 982 Mn = 2000 |
| | (Manufactured by Tosoh Corporation) |
| A-5 | ETERNACOLL UM-90(1:3) Mn = 900 |
| | (Manufactured by Ube Industries, Ltd.) |

### Synthesis of Raw Polyol A-6

Under a nitrogen atmosphere, 100.0 g of 1,3-propanediol, 49.4 g of adipic acid, and 69.5 g of ethylene carbonate were mixed and heated, and ethylene glycol and water formed from the reaction system were distilled off while raising the temperature to 200° C. After ethylene glycol and water were distilled off, 15 ppm of titanium tetraisopropoxide was added, and the polycondensation reaction was further allowed to proceed under a reduced pressure of 266.7 Pa. The reaction liquid was cooled to room temperature to yield a raw polyol A-6. The number average molecular weight of the resulting raw polyol A-6 was 2030.

### Synthesis of Raw Polyol A-7

A raw polyol A-7 was synthesized in the same manner as in the case of the raw polyol A-6 except that the starting materials shown in Table 2 below were used. The number average molecular weight of the raw polyol A-7 was 2040.

TABLE 2

| | | Dicarboxylic | | | Number average |
|---|---|---|---|---|---|
| Raw polyol | Diol | acid | Ethylene carbonate | Ester group/carbonate | molecular |
| No. | (Parts by mass) | (Parts by mass) | Parts by mass | group (Molar ratio) | weight |
| A-6 | 1,3-propanediol | Adipic acid | 69.5 | 3/7 | 2030 |
| | (100.0) | (49.4) | | | |
| A-7 | 1,6-hexanediol | Sebacic acid | 19.2 | 7/3 | 2040 |
| | (100.0) | (102.8) | | | |

### 1-2. Preparation of Raw Isocyanates B-1 to B-3

Raw isocyanates shown in Table 3 below were prepared.

TABLE 3

| No. | Raw isocyanate |
|---|---|
| B-1 | Diphenylmethane diisocyanate (MDI) |
| | Trade name: Millionate MT Manufactured by |
| | Tosoh Corporation) |
| B-2 | Polymethylene polyphenyl polyisocyanate |
| | (polymeric MDI) |
| | (Trade name: Millionate MR200 Manufactured by |
| | Tosoh Corporation) |
| B-3 | Isocyanurate trimer of hexamethylene diisocyanate |
| | Trade name: Duranate TPA-100 Manufactured |
| | by Asahi Kasei Chemicals Corporation) |

### 1-3. Production Examples of Hydroxyl-Terminated Urethane Prepolymers C-1 to C-3

### Synthesis of Hydroxyl-Terminated Urethane Prepolymer C-1

Under a nitrogen atmosphere, the materials shown in Table 4 below were heated and stirred at a temperature of 90° C. for 3 hours to cause a reaction. After that, 2-butanone (MEK) was added to the resulting reaction product to prepare a hydroxyl-terminated urethane prepolymer C-1 as a solution with a solid content of 50 parts by mass.

TABLE 4

| | Parts |
|---|---|
| Material | by mass |
| Raw polyol A-1 (Trade name: Duranol | 100 |
| T5652 Manufactured by Asahi Kasei | |
| Chemicals Corporation) | |
| Raw isocyanate B-1 (Trade name: Millionate | 6.3 |
| MT Manufactured by Tosoh Corporation) | |

### Synthesis of Hydroxyl-Terminated Urethane Prepolymers C-2 to C-5

Hydroxyl-terminated urethane prepolymers C-2 to C-5 were synthesized in the same manner as in the case of the synthesis of the hydroxyl-terminated urethane prepolymer C-1 except that the starting materials shown in Table 5 below were used.

The chemical structures of these hydroxyl-terminated urethane prepolymers C-1 to C-5 were identified using ¹H-NMR and ¹³C-NMR. It is to be noted that in Table 5, m, n, q, r, and s in structural formulae (1), (3), and (4) are the average numbers of moles added.

TABLE 5

| Hydroxyl- | | | | | | | | |
|---|---|---|---|---|---|---|---|---|
| terminated | | | | | | | | |
| urethane | | | Raw | | | | | |
| prepolymer | Raw polyol | | isocyanate | | | | | |
| No. | No. | Parts | No. | Parts | Structure contained in molecule | | | |
| C-1 | A-1 | 100 | B-1 | 6.3 | Structural formula (1) | R11 = (CH₂)₅ | R12 = (CH₂)₆ | m, n = 6.9 |
| C-2 | A-2 | 100 | B-1 | 6.3 | Structural formula (1) | R11 = (CH₂)₃ | R12 = (CH₂)₄ | m, n = 8.8 |
| C-3 | A-3 | 100 | B-1 | 6.3 | Structural formula (4) | R41 = (CH₂)₆ | | s = 13.2 |
| C-4 | A-6 | 100 | B-1 | 6.3 | Structural formula (3) | R31 = (CH₂)₃ | R32 = (CH₂)₄ | q = 12, r = 5.1 |
| C-5 | A-7 | 100 | B-1 | 6.3 | Structural formula (3) | R31 = (CH₂)₆ | R32 = (CH₂)₈ | q = 2.7, r = 6.3 |

Regarding the hydroxyl group-terminated urethane prepolymers C-1 and C-2 containing the structure represented by structural formula (1) in the molecule, R13 in structural formula (1) was the same as R12.

In the table, with respect to the description of “x, y=A” such as m, n=6.9, it indicates that the average numbers of moles added of each of x and y is A. The same applies to the following tables. The term “parts” represents “parts by mass”.

### 1-4. Production Examples of Isocyanate Group-Terminated Prepolymers D-1 to D-3

### Synthesis of Isocyanate Group-Terminated Prepolymer D-1

Under a nitrogen atmosphere, the materials shown in Table 6 below were heated and stirred at a temperature of 90° C. for 3 hours to cause a reaction. After that, 2-butanone (MEK) was added to the resulting reaction product to prepare a solution with a solid content of 50 parts by mass, and an isocyanate group-terminated prepolymer D-1 was prepared.

TABLE 6

| | Parts |
|---|---|
| Material | by mass |
| Raw polyol A-4 (Trade name: Nippolan | 100 |
| 982 Manufactured by Tosoh Corporation) | |
| Raw polyisocyanate B-2 (Trade name: | 33.5 |
| Millionate MR200 Manufactured by | |
| Tosoh Corporation) | |

### Synthesis of Isocyanate Group-Terminated Prepolymers D-2 and D-3

Isocyanate group-terminated prepolymers D-2 and D-3 were prepared in the same manner as in the case of the synthesis of the isocyanate group-terminated prepolymer D-1 except that starting materials of the type and amount shown in Table 7 below were used.

The chemical structures of these isocyanate group-terminated prepolymers D-1 to D-3 were identified using ¹H-NMR and ¹³C-NMR. It is to be noted that in Table 7, m, n, o, p, and s in structural formulae (1), (2), and (4) are the average numbers of moles added. The term “parts” represents “parts by mass”.

TABLE 7

| Isocyanate | | | | | | | | |
|---|---|---|---|---|---|---|---|---|
| group- | | | Raw | | | | | |
| terminated | Raw polyol | | isocyanate | | | | | |
| prepolymer No. | No. | Parts | No. | Parts | Structure contained in molecule | | | |
| D-1 | A-4 | 100 | B-2 | 33.5 | Structural formula (2) | o = 9.1, p = 5.5 | | |
| D-2 | A-5 | 100 | B-3 | 78.4 | Structural formula (1) | R11 = (CH₂)₆ | 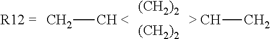 | m = 4.1, n = 1.4 |

| | | | | | | | |
|---|---|---|---|---|---|---|---|
| D-3 | A-3 | 100 | B-2 | 33.5 | Structural formula (4) | R41 = (CH₂)₆ | s = 13.2 |

Regarding the isocyanate group-terminated prepolymer D-2 containing the structure represented by structural formula (1) in the molecule, R13 in structural formula (1) was the same as at least one selected from the group consisting of R11 and R12.

### 2. PREPARATION OF CONDUCTIVE LAYER ADDITIVE, AND PRODUCTION

### 2-1. Preparation of Polyoxyethylene Polyoxypropylene Alkyl Ethers E-1 and E-2, and Production Examples

### Preparation of Polyoxyethylene Polyoxypropylene Alkyl Ether

Commercial products were used for additives E-1 and E-2 which are polyoxyethylene polyoxypropylene alkyl ethers shown in Table 8 below.

### 2-2. Preparation of Polyoxyethylene Alkyl Ether Acetate, and Production Example

### Preparation of Polyoxyethylene Alkyl Ether Acetate

E-3, which is a polyoxyethylene alkyl ether acetate as an additive, shown in Table 8 below, was synthesized.

### Synthesis of Polyoxyethylene Alkyl Ether Acetate E-3.

First, 55.0 g of polyoxyethylene methyl ether (trade name: BLAUNON MP-550, manufactured by AOKI OIL INDUSTRIAL Co., Ltd., the average number of moles of ethylene oxide added is 12 mol with respect to alcohol) and 510 ml of a 1 mol/L aqueous sodium hydroxide solution were mixed, then 71.1 g of potassium permanganate was added, and stirred at room temperature for 6 hours. After that, 760 ml of 2-propanol was added and stirred for 1 hour to quench the excess potassium permanganate, and the by-product manganese oxide was filtered. The aqueous layer was extracted with dichloromethane and purified to yield E-3, which is polyoxyethylene methyl ether acetate. Table 8 shows the structure of R71 in E-3 and the value of x.

### 2-3. Preparation of Polyetheramine and Production Example

### Preparation of Polyetheramine

A commercial product was used for an additive E-4 which is a polyetheramine shown in Table 8 below.

TABLE 8

| No. | Additive | Structure | | |
|---|---|---|---|---|
| E-1 | Polyoxyethylene polyoxypropylene butyl ether | Structural formula (5) | R51 = C₄H₉ | t, u = 17 |
| | (Trade name: UNILUBE 50 MB-26 | | | |
| | Manufactured by NOF CORPORATION) | | | |
| E-2 | Polyoxyethylene polyoxypropylene butyl ether | Structural formula (5) | R51 = C₄H₉ | t = 9, u = 10 |
| | (Trade name: UNILUBE 50 MB-11 | | | |
| | Manufactured by NOF CORPORATION | | | |
| E-3 | Polyoxyethylene methyl ether acetate | Structural formula (7) | R71 = CH₃ | x = 11 |
| E-4 | Polyetheramine (Trade name: JEFFAMINE M-2005 | Structural formula (6) | R61 = CH₃ | v = 6, w = 29 |
| | Manufactured by Huntsman Corporation) | | | |

### 3. PRODUCTION EXAMPLES OF CONDUCTIVE LAYER-FORMING COATING LIQUID

### 3-1. Preparation of Conductive Layer-Forming Coating Liquid F-1

As the material for a conductive layer-forming coating liquid F-1, materials of the type and amount shown in Table 9 below were added to the inside of the reaction vessel and stirred. Next, 2-butanone (EK) was added so that the total solid ratio is 30 mass %, and then mixed with a sand mill. Subsequently, 2-butanone (MEK) was added to adjust the viscosity of the liquid within the range of 6 to 10 mPa·s to prepare the conductive layer-forming coating liquid F-1.

TABLE 9

| | Parts |
|---|---|
| Material | by mass |
| Hydroxyl-terminated urethane prepolymer C-1 | 100 |
| Isocyanate group-terminated urethane prepolymer D-5 | 54.7 |
| Additive E-1 | 7 |
| Surface adjusting agent (Trade name: TSF4445, | 0.8 |
| Manufactured by Momentive Performance Materials, Inc.) | |
| Carbon black (Trade name: MA8, Manufactured | 35 |
| by Mitsubishi Chemical Corporation) | |
| Coarse particles (Trade name: ART PEARL | 23 |
| C-400T, Negami Chemical Industrial Co., Ltd.) | |

### 3-2. Preparation of Conductive Layer-Forming Coating Liquids F-2 to F-13

Conductive layer-forming coating liquids F-2 to F-13 were prepared by the following method. First, a hydroxyl group-terminated urethane prepolymer, an isocyanate group-terminated prepolymer, an additive, a surface adjusting agent, a carbon black, and coarse particles shown in Table 10 below were mixed in the same manner as in the case of the preparation of the conductive layer-forming coating liquid F-1. Thereafter, 2-butanone (MVEK) was added to adjust the viscosity of the liquid within the range of 6 to 10 mPa·s to prepare the conductive layer-forming coating liquids F-2 to F-13.

TABLE 10

| Conductive | | | Isocyanate group- | | | | Surface | | |
|---|---|---|---|---|---|---|---|---|---|
| layer- | Hydroxyl-terminated | | terminated urethane | | | | adjusting | Carbon | Coarse |
| forming | urethane prepolymer | | prepolymer | | Additive | | agent | black | particles |
| coating | | Parts by | | Parts by | | Parts by | Parts by | Parts by | Parts by |
| liquid No. | No. | mass | No. | mass | No. | mass | mass | mass | mass |
| F-1 | C-1 | 100 | D-3 | 54.7 | E-1 | 7 | 0.8 | 35 | 23 |
| F-2 | C-2 | 100 | D-3 | 54.7 | E-1 | 7 | 0.8 | 35 | 23 |
| F-3 | C-3 | 100 | D-2 | 54.7 | E-1 | 7 | 0.8 | 35 | 23 |
| F-4 | C-1 | 100 | D-1 | 54.7 | E-1 | 7 | 0.8 | 35 | 23 |
| F-5 | C-2 | 100 | D-1 | 54.7 | E-1 | 7 | 0.8 | 35 | 23 |
| F-6 | C-4 | 100 | D-3 | 54.7 | E-1 | 7 | 0.8 | 35 | 23 |
| F-7 | C-5 | 100 | D-3 | 54.7 | E-1 | 7 | 0.8 | 35 | 23 |
| F-8 | C-3 | 100 | D-1 | 54.7 | E-1 | 7 | 0.8 | 35 | 23 |
| F-9 | C-1 | 100 | D-3 | 54.7 | E-1 | 6.6 | 0.8 | 35 | 23 |
| F-10 | C-1 | 100 | D-3 | 54.7 | E-1 | 16.1 | 0.8 | 35 | 23 |
| F-11 | C-1 | 100 | D-3 | 54.7 | E-2 | 7 | 0.8 | 35 | 23 |
| F-12 | C-1 | 100 | D-3 | 54.7 | E-4 | 7 | 0.8 | 35 | 23 |
| F-13 | C-1 | 100 | D-3 | 54.7 | E-3 | 7 | 0.8 | 35 | 23 |

### 4. PRODUCTION EXAMPLE OF CONDUCTIVE LAYER ROLLER

### 4-1. Preparation of Substrate

A substrate was prepared by coating a core metal made of stainless steel: SUS304 and having a diameter of 6 mm with a primer (trade name “DY35-051”; manufactured by Dow Toray Co., Ltd.), followed by baking.

### 4-2. Preparation of Elastic Layer

The substrate was placed in a mold, and an addition-type silicone rubber composition obtained by mixing the materials shown in Table 11 was injected into a cavity formed in the mold.

TABLE 11

| | Parts |
|---|---|
| Material | by mass |
| Liquid silicone rubber | 100 |
| (Trade name: SE6724 A/B, Manufactured by | |
| Dow Toray Co., Ltd.) | |
| Carbon black | 16 |
| (Trade name: TOKABLACK #4300, Manufactured | |
| by Tokai Carbon Co., Ltd.) | |
| Curing control agent | 0.01 |
| (Trade name: 1-Ethynyl-1-cyclohexanol, | |
| Manufactured by Tokyo Chemical Industry Co., Ltd.) | |
| Platinum catalyst | 0.01 |
| (Trade name: SIP6830.3, Manufactured | |
| by GELEST, Inc.) | |

Subsequently, the mold was heated to vulcanize and cure the silicone rubber at a temperature of 150° C. for 15 minutes, and the silicone rubber was demolded, and then further heated at a temperature of 180° C. for 1 hour to complete the curing reaction to obtain an elastic roller provided with an elastic layer with a diameter of 11.5 mm on the outer periphery of the substrate.

### 4-3. Production Example of Conductive Layer Roller G-1

The elastic roller was held at the upper end thereof with the longitudinal direction set to the vertical direction, and immersed (dipped) in the conductive layer-forming coating liquid F-1 to coat the surface of the elastic roller with the coating liquid. The resulting coated matter was air-dried at normal temperature for 30 minutes and then cured by drying in a hot air-circulating drier set at 160° C. for 1 hour. In this way, a conductive layer roller G-1 having a conductive layer with a film thickness of 12 μm formed on the elastic layer was obtained.

### 4-4. Production Example of Conductive Layer Rollers G-2 to G-13

Conductive layer rollers G-2 to G-13 were prepared in the same manner as in the production example of the conductive layer roller G-1 except that in the production example of the conductive layer roller G-1, the conductive layer-forming coating liquid F-1 was changed to F-2 to F-13 shown in Table 12 below.

TABLE 12

| | Conductive | | | | | |
|---|---|---|---|---|---|---|
| | layer- | | | | | |
| Conductive | forming | | | | | |
| layer | coating | | | | | |
| roller | liquid | Binder resin structure | | | | |
| No. | No. | Structure 1 | | | | Structure 2 |
| G-1 | F-1 | F. (1) | R11 = (CH₂)₅ | R12 = (CH₂)₆ | m,n = 6.9 | F. (4) |
| G-2 | F-2 | F. (1) | R11 = (CH₂)₃ | R12 = (CH₂)₄ | m,n = 8.8 | F. (4) |
| G-3 | F-3 | F. (4) | R41 = (CH₂)₆ | | s = 13.2 | F. (1) |
| G-4 | F-4 | F. (1) | R11 = (CH₂)₅ | R12 = (CH₂)₆ | m,n = 6.9 | F. (2) |
| G-5 | F-5 | F. (1) | R11 = (CH₂)₃ | R12 = (CH₂)₄ | m,n = 8.8 | F. (2) |
| G-6 | F-6 | F. (3) | R31 = (CH₂)₃ | R32 = (CH₂)₄ | q = 12, r = 5.1 | F. (4) |
| G-7 | F-7 | F. (3) | R31 = (CH₂)₆ | R32 = (CH₂)₈ | q = 2.7, r = 6.3 | F. (4) |
| G-8 | F-8 | F. (4) | R41 = (CH₂)₆ | | s = 13.2 | F. (2) |
| G-9 | F-9 | F. (1) | R11 = (CH₂)₅ | R12 = (CH₂)₆ | m,n = 6.9 | F. (4) |
| G-10 | F-10 | F. (1) | R11 = (CH₂)₅ | R12 = (CH₂)₆ | m,n = 6.9 | F. (4) |
| G-11 | F-11 | F. (1) | R11 = (CH₂)₅ | R12 = (CH₂)₆ | m,n = 6.9 | F. (4) |
| G-12 | F-12 | F. (1) | R11 = (CH₂)₅ | R12 = (CH₂)₆ | m,n = 6.9 | F. (4) |
| G-13 | F-13 | F. (1) | R11 = (CH₂)₅ | R12 = (CH₂)₆ | m,n = 6.9 | F. (4) |

| Con- | | | | | | |
|---|---|---|---|---|---|---|
| ductive | | | | | | |
| layer | | | | | | |
| roller | Binder resin structure | | | Additive | | |
| No. | Structure 2 | | | structure | | |
| G-1 | R41 = (CH₂)₆ | | s = 13.2 | F. (5) | R51 = C₄H₉ | t,u = 17 |
| G-2 | R41 = (CH₂)₆ | | s = 13.2 | F. (5) | R51 = C₄H₉ | t,u = 17 |
| G-3 | R11 = (CH₂)₆ | 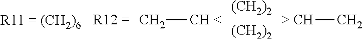 | m = 4.1, n = 1.4 | F. (5) | R51 = C₄H₉ | t,u = 17 |

| G-4 | o = 9.1, p = 5.5 | | F. (5) | R51 = C₄H₉ | t,u = 17 |
|---|---|---|---|---|---|
| G-5 | o = 9.1, p = 5.5 | | F. (5) | R51 = C₄H₉ | t,u = 17 |
| G-6 | R41 = (CH₂)₆ | s = 13.2 | F. (5) | R51 = C₄H₉ | t,u = 17 |
| G-7 | R41 = (CH₂)₆ | s = 13.2 | F. (5) | R51 = C₄H₉ | t,u = 17 |
| G-8 | o = 9.1, p = 5.5 | | F. (5) | R51 = C₄H₉ | t,u = 17 |
| G-9 | R41 = (CH₂)₆ | s = 13.2 | F. (5) | R51 = C₄H₉ | t,u = 17 |
| G-10 | R41 = (CH₂)₆ | s = 13.2 | F. (5) | R51 = C₄H₉ | t,u = 17 |
| G-11 | R41 = (CH₂)₆ | s = 13.2 | F. (5) | R51 = C₄H₉ | t = 9, |
| | | | | | u = 10 |
| G-12 | R41 = (CH₂)₆ | s = 13.2 | F. (6) | R61 = CH₃ | v = 6, |
| | | | | | w = 29 |
| G-13 | R41 = (CH₂)₆ | s = 13.2 | F. (7) | R71 = CH₃ | x = 11 |

In Table 12, “E” represents “Formula”.

### 5. PREPARATION OF INSULATING PORTION-FORMING MATERIAL, AND PRODUCTION

### 5-1. Production Examples of Insulating Portion-Forming Materials I-1 to I-5

### Preparation of Raw Material Monomers

Commercial products were used for H-1 to H-4, which are 4 types of raw material monomers shown in Table 13 below.

TABLE 13

| No. | Material name |
|---|---|
| H-1 | 2,2-bis(4-hydroxyphenyl)propane |
| | (Trade name: Manufactured by Tokyo Chemical Industry Co., |
| | Ltd., Product code B0494) |
| H-2 | 2,2-bis(3-methyl-4-hydroxyphenyl)propane |
| | (Trade name: Manufactured by Tokyo Chemical Industry Co., |
| | Ltd., Product code B1567) |
| H-3 | 1,1-bis(4-hydroxyphenyl)-1-phenylethane |
| | (Trade name: Manufactured by Tokyo Chemical Industry Co., |
| | Ltd., Product code M1098) |
| H-4 | 2,2-bis(4-hydroxyphenyl)-4-methylpentane |
| | (Trade name: Manufactured by Tokyo Chemical Industry Co., |
| | Ltd., Product code D3267) |

### Synthesis of Insulating Portion-Forming Material I-1

In 1100 ml of a 5 mass % aqueous sodium hydroxide solution, 42.5 g of 2,2-bis(4-hydroxyphenyl)propane (manufactured by Tokyo Chemical Industry Co., Ltd., product code B0494), 37.5 g of 2,2-bis(3-methyl-4-hydroxyphenyl)propane (manufactured by Tokyo Chemical Industry Co., Ltd., product code B1567), and 0.1 g of hydrosulfite were dissolved. To this mixture, 500 ml of methylene chloride was added and stirred, and 60 g phosgene was then blown thereinto in 60 minutes while the mixture was kept at 15° C.

After the blowing of the phosgene ended, 1.3 g of p-t-butylphenol (hereinafter, abbreviated as “PTBP”; manufactured by Tokyo Chemical Industry Co., Ltd., product code: B0383) was added thereto as a molecular weight modifier and was stirred to emulsify the reaction liquid. After emulsifying, 0.4 ml of triethylamine was added thereto and was stirred at 23° C. for 1 hour to cause polymerization.

After completion of the polymerization, the reaction liquid was separated into an aqueous phase and an organic phase, the organic phase was neutralized with phosphoric acid, and washing with water was repeated until the conductivity of the washing liquid (aqueous phase) reached 10 μS/cm or less. The obtained polymer solution was added dropwise to warm water kept at 45° C., and the solvent was removed by evaporation to obtain a white powder precipitate. The obtained precipitate was filtered and dried at 110° C. for 24 hours to obtain an insulating portion-forming material I-1.

### Measurement of Weight-Average Molecular Weight of Insulating Portion-Forming Material I-1

The apparatus used to measure the weight-average molecular weight (Mw) of the insulating portion-forming material in the present production example, and conditions are as follows.

First, a sample is dissolved in tetrahydrofuran (TIF) at room temperature for 24 hours. Then, the obtained solution is filtered through a solvent-resistant membrane filter “Mysyori Disc” (manufactured by Tosoh Corporation) with a pore size of 0.5 μm, thereby obtaining a sample solution. Note that the sample solution is prepared to have a concentration of 0.5 mass %. This sample solution is measured under the following conditions:
Apparatus: HLC-8320GPC (detector: RI) (manufactured by Tosoh Corporation)
Column: Shodex LF-404, LF-404 tandem (manufactured by Showa Denko K.K.)
Eluent: Tetrahydrofuran (TIF)
Flow rate: 0.4 ml/min
Oven temperature: 40.0° C.
Sample injection amount: 0.10 ml

To calculate the molecular weight of the sample, a molecular weight calibration curve created using a standard polystyrene resin (for example, trade name “EasiVial PS-H polystyrene”; manufactured by Agilent Technology) was used.

The molecular weight of the insulating portion-forming material I-1 was measured and found to be Mw=56000.

### Synthesis of Insulating Portion-Forming Materials I-2 to I-5

Insulating portion-forming materials I-2 to I-5 were prepared in the same manner as in the case of the synthesis of the insulating portion-forming material I-1 except that the starting materials shown in Table 14-1 below were used.

The chemical structures and molar ratios of these insulating portion-forming materials I-1 to I-5 were specified using ¹H-NMR and ¹³C-NMR.

TABLE 14-1
Insulating

| portion- | Raw material | | Raw material | | | | |
|---|---|---|---|---|---|---|---|
| forming | monomer 1 | | monomer 2 | | Structure contained in molecule | | Molecular |
| material | | Parts by | | Parts by | | Molar | weight |
| No. | No. | mass | No. | mass | Structural formula | ratio | Mw |
| I-1 | H-1 | 42.5 | I-2 | 37.5 | Structural formula (9) | 0.4 | 56000 |
| I-2 | H-3 | 45.8 | I-4 | 34.2 | Structural formula (10)/ | 0.5/0.5 | 61000 |
| | | | | | Structural formula (11) | | |
| I-3 | H-1 | 62.5 | I-2 | 17.5 | Structural formula (9) | 0.2 | 62000 |
| I-4 | H-2 | 80.8 | — | — | Structural formula (9) | 1.0 | 72000 |
| I-5 | H-4 | 85.2 | — | — | Structural formula (10) | 1.0 | 64000 |

### 5-2. Preparation of Insulating Portion-Forming Material I-6, and Production Example

A commercial product was used for an acrylate monomer shown in Table 14-2 below.

TABLE 14-2

| Insulating | |
|---|---|
| portion-forming | |
| material No. | Material name |
| 1-6 | Pentaerythritol tetraacrylate (Trade name: |
| | A-TMMT Manufactured by Shin-Nakamura |
| | Chemical Co., Ltd.) |

### 6. PRODUCTION EXAMPLES OF INSULATING PORTION-FORMING COATING LIQUIDS

### 6-1. Preparation of Insulating Portion-Forming Coating Liquid J-1

The insulating portion-forming material I-1 in an amount of 100 parts by mass was weighed, MEK was added so that the concentration was 2.0 mass %, and the material was dissolved well to prepare an insulating portion-forming coating liquid J-1.

### 6-2. Preparation of Insulating Portion-Forming Coating Liquids J-2 to J-7

Insulating portion-forming coating liquids J-2 to J-7 were prepared in the same manner as the insulating portion-forming coating liquid J-1 except that in the preparation of the insulating portion-forming coating liquid J-1, the insulating portion-forming material was changed to the materials and concentrations shown in Table 15 below.

### 6-3. Preparation of Insulating Portion-Forming Coating Liquid J-8

The insulating portion-forming material I-6 in an amount of 100 parts by mass was weighed, then 5.0 parts by mass of a photopolymerization initiator (trade name: Omnirad184 IGM Resins Co., Ltd.) was weighed, MEK was added so that the concentration was 2.0 mass %, and the contents were dissolved well to prepare an insulating portion-forming coating liquid J-8.

TABLE 15

| Insulating | | | | | |
|---|---|---|---|---|---|
| portion- | Insulating portion- | | Photopolymerization | | |
| forming | forming material | | initiator | | |
| coating | | Parts | Material | Parts | Concentration |
| liquid No. | No. | by mass | name | by mass | Mass % |
| J-1 | 1-1 | 100 | — | — | 2.0 |
| J-2 | 1-1 | 50 | — | — | 1.0 |
| J-3 | 1-1 | 350 | — | — | 7.0 |
| J-4 | 1-2 | 100 | — | — | 2.0 |
| 3-5 | 1-3 | 100 | — | — | 2.0 |
| J-6 | 1-4 | 100 | — | — | 2.0 |
| J-7 | 1-5 | 100 | — | — | 2.0 |
| J-8 | 1-6 | 100 | Omnirad184 | 5.0 | 2.0 |

### 7. PRODUCTION EXAMPLES OF DEVELOPING ROLLERS AND COMPARATIVE DEVELOPING ROLLERS

### 7-1. Production Example of Developing Roller K-1

The conductive layer roller G-1 was held at the upper end thereof with the longitudinal direction set to the vertical direction, and immersed (dipped) in the insulating portion-forming coating liquid J-1 to coat the surface of the conductive layer roller G-1 with the coating liquid. The resulting coated matter was air-dried at normal temperature for 30 minutes and then dried in a hot air-circulating drier set at 90° C. for 1 hour. In this way, the developing roller K-1 in which the insulating portion was formed on the conductive layer was obtained. The physical properties of the developing roller K-1 are shown in Table 16-1 and Table 16-2.

### 7-2. Production Examples of Developing Rollers K-2 to K-19

Developing rollers K-2 to K-19 were obtained in the same manner as the developing roller K-1 except that in the production example of the developing roller K-1, the conductive layer roller and the insulating portion-forming coating liquid were changed to those shown in Table 16-1 below. The physical properties of the developing rollers K-2 to K-19 are shown in Tables 16-1 and 16-2.

### 7-3. Production Example of Developing Roller K-20

The conductive layer roller G-1 was held at the upper end thereof with the longitudinal direction set to the vertical direction, and immersed (dipped) in the insulating portion-forming coating liquid J-8 to coat the surface of the conductive layer roller G-1 with the coating liquid. The resulting coated matter was air-dried at normal temperature for 30 minutes and then dried in a hot air-circulating drier set at 90° C. for 1 hour to obtain a conductive layer roller G-1 to which a mixture of the insulating portion-forming material and the photopolymerization initiator was attached.

Thereafter, the outer surface of the conductive layer roller G-1 was irradiated with ultraviolet rays such that the cumulative light quantity became 2000 mJ/cm² to cure the insulating portion-forming material. In this way, the developing roller K-20 in which the insulating portion was formed on the conductive layer was obtained. A high-pressure mercury lamp (trade name: handy-type UV curing apparatus, manufactured by Marionetwork) was used as the ultraviolet irradiation apparatus. The physical properties of the developing roller K-20 are shown in Table 16-1 and Table 16-2.

TABLE 16-1

| | | | Physical properties of conductive layer | | | | | |
|---|---|---|---|---|---|---|---|---|
| | | | Physical properties of carbon | | | | | |
| | Insulating | | black | | | | | |
| | portion- | | Primary | DBP | | Minimum | Surface | |
| | forming | Conductive | particle | absorption | | value of | potential | |
| Developing | coating | layer roller | diameter | amount | | impedance | V_{\|N\|} − V₁ | T₂ |
| roller No. | liquid No. | No. | [nm] | [ml/100 g] | pH | [Ω] | [V] | [Sec] |
| K-1 | J-1 | G-1 | 24 | 51 | 2.5 | 9.1E+06 | 5.7 | 2.6 |
| K-2 | J-1 | G-2 | 24 | 51 | 2.5 | 8.7E+06 | 2.5 | 4.1 |
| K-3 | J-1 | G-3 | 24 | 51 | 2.5 | 7.46+06 | 14.2 | 4.6 |
| K-4 | J-1 | G-4 | 24 | 51 | 2.5 | 2.8E+06 | 3.2 | 1.8 |
| K-5 | J-1 | G-5 | 24 | 51 | 2.5 | 1.5E+06 | 3.2 | 1.5 |
| K-6 | J-1 | G-6 | 24 | 51 | 2.5 | 2.1E+06 | 3.5 | 1.6 |
| K-7 | J-1 | G-7 | 24 | 51 | 2.5 | 2.0E+06 | 3.8 | 1.6 |
| K-8 | J-1 | G-8 | 24 | 51 | 2.5 | 2.4E+06 | 3.2 | 1.9 |
| K-9 | J-1 | G-9 | 24 | 51 | 2.5 | 8.6E+06 | 4.5 | 1.9 |
| K-10 | J-1 | G-10 | 24 | 51 | 2.5 | 6.6E+06 | 7.2 | 1.8 |
| K-11 | J-1 | G-11 | 24 | 51 | 2.5 | 7.7E+06 | 6.4 | 1.8 |
| K-12 | J-1 | G-12 | 24 | 51 | 2.5 | 6.3E+06 | 5.1 | 1.6 |
| K-13 | J-1 | G-13 | 24 | 51 | 2.5 | 2.2E+06 | 3.8 | 1.5 |
| K-14 | J-2 | G-1 | 24 | 51 | 2.5 | 9.1E+06 | 5.7 | 2.5 |
| K-15 | J-3 | G-1 | 24 | 51 | 2.5 | 9.1E+06 | 5.7 | 2.6 |
| K-16 | J-4 | G-1 | 24 | 51 | 2.5 | 9.1E+06 | 5.7 | 2.5 |
| K-17 | J-5 | G-1 | 24 | 51 | 2.5 | 9.1E+06 | 5.7 | 2.5 |
| K-18 | J-6 | G-1 | 24 | 51 | 2.5 | 9.1E+06 | 5.7 | 2.5 |
| K-19 | J-7 | G-1 | 24 | 51 | 2.5 | 9.1E+06 | 5.7 | 2.5 |
| K-20 | J-8 | G-1 | 24 | 51 | 2.5 | 9.1E+06 | 5.7 | 1.5 |

| | Physical properties of conductive layer | | | | | |
|---|---|---|---|---|---|---|
| | Dispersion state of carbon black | | | | | |
| | Dispersion circle-equivalent | | | | | |
| | diameter | | | | | |
| | | Standard | | Inter-wall distance | | |
| | Mean | deviation | | | Standard | |
| Developing | Rc | σc | | Mean d | deviation | |
| roller No. | [nm] | [nm] | σc/Rc | [nm] | σd | σd/d |
| K-1 | 55.2 | 33.1 | 0.600 | 111.6 | 64.1 | 0.574 |
| K-2 | 55.9 | 32.9 | 0.589 | 108.9 | 62.1 | 0.570 |
| K-3 | 52.1 | 31.1 | 0.597 | 102.3 | 57.2 | 0.559 |
| K-4 | 54.3 | 31.8 | 0.586 | 100.7 | 56.9 | 0.565 |
| K-5 | 59.2 | 38.0 | 0.642 | 103.8 | 57.2 | 0.551 |
| K-6 | 58.0 | 34.7 | 0.598 | 106.5 | 60.9 | 0.572 |
| K-7 | 59.1 | 34.9 | 0.591 | 104.9 | 61.1 | 0.582 |
| K-8 | 58.2 | 35.3 | 0.607 | 105.8 | 60.9 | 0.576 |
| K-9 | 57.4 | 34.5 | 0.601 | 99.8 | 56.6 | 0.567 |
| K-10 | 56.1 | 34.2 | 0.610 | 101.2 | 57.0 | 0.563 |
| K-11 | 57.0 | 34.9 | 0.612 | 98.7 | 56.7 | 0.574 |
| K-12 | 55.0 | 32.0 | 0.582 | 102.3 | 57.4 | 0.561 |
| K-13 | 58.9 | 37.0 | 0.628 | 143.5 | 83.2 | 0.580 |
| K-14 | 55.2 | 33.1 | 0.600 | 111.6 | 64.1 | 0.574 |
| K-15 | 55.2 | 33.1 | 0.600 | 111.6 | 64.1 | 0.574 |
| K-16 | 55.2 | 33.1 | 0.600 | 111.6 | 64.1 | 0.574 |
| K-17 | 55.2 | 33.1 | 0.600 | 111.6 | 64.1 | 0.574 |
| K-18 | 55.2 | 33.1 | 0.600 | 111.6 | 64.1 | 0.574 |
| K-19 | 55.2 | 33.1 | 0.600 | 111.6 | 64.1 | 0.574 |
| K-20 | 55.2 | 33.1 | 0.600 | 111.6 | 64.1 | 0.574 |

In the table, for example, 9.1E+06 indicates 9.1×10⁶. The same applies to the other tables below. The minimum value of the impedance indicates the minimum value of the impedance value at a frequency of 1.0×10⁰ Hz to 1.0×10¹ Hz.

TABLE 16-2

| | | | Physical properties of insulating portion | | | |
|---|---|---|---|---|---|---|
| | Insulating | | Proportion of | Volume | | |
| | portion- | | total area of | resistivity of | Surface | |
| | forming | Conductive | insulating | insulating | potential | |
| Developing | coating | layer roller | portion | portion | V₁ | T₁ |
| roller No. | liquid No. | No. | [%] | [Ω · cm] | [V] | [Sec] |
| K-1 | J-1 | G-1 | 30 | 2.8 × 10\hat{ }14 | 15.2 | 2971.6 |
| K-2 | J-1 | G-2 | 31 | 2.8 × 10\hat{ }14 | 14.6 | 2895.6 |
| K-3 | J-1 | G-3 | 30 | 2.8 × 10\hat{ }14 | 14.7 | 2812.2 |
| K-4 | J-1 | G-4 | 30 | 2.8 × 10\hat{ }14 | 15.0 | 2787.3 |
| K-5 | J-1 | G-5 | 30 | 2.8 × 10\hat{ }14 | 14.7 | 3047.9 |
| K-6 | J-1 | G-6 | 30 | 2.8 × 10\hat{ }14 | 15.4 | 3202.1 |
| K-7 | J-1 | G-7 | 30 | 2.8 × 10\hat{ }14 | 14.9 | 3129.8 |
| K-8 | J-1 | G-8 | 30 | 2.8 × 10\hat{ }14 | 15.2 | 3095.8 |
| K-9 | J-1 | G-9 | 29 | 2.8 × 10\hat{ }14 | 15.1 | 2888.1 |
| K-10 | J-1 | G-10 | 30 | 2.8 × 10\hat{ }14 | 14.9 | 3136.3 |
| K-11 | J-1 | G-11 | 30 | 2.8 × 10\hat{ }14 | 14.9 | 2922.2 |
| K-12 | J-1 | G-12 | 30 | 2.8 × 10\hat{ }14 | 14.7 | 2796.4 |
| K-13 | J-1 | G-13 | 30 | 2.8 × 10\hat{ }14 | 15.0 | 2917.4 |
| K-14 | J-2 | G-1 | 15 | 2.8 × 10\hat{ }14 | 6.8 | 2782.0 |
| K-15 | J-3 | G-1 | 49 | 2.8 × 10\hat{ }14 | 30.1 | 2922.5 |
| K-16 | J-4 | G-1 | 30 | 2.9 × 10\hat{ }14 | 15.2 | 2940.8 |
| K-17 | J-5 | G-1 | 30 | 2.4 × 10\hat{ }14 | 14.9 | 2627.9 |
| K-18 | J-6 | G-1 | 30 | 3.5 × 10\hat{ }14 | 14.8 | 4200.4 |
| K-19 | J-7 | G-1 | 30 | 3.5 × 10\hat{ }14 | 14.7 | 3083.3 |
| K-20 | J-8 | G-1 | 30 | 7.9 × 10\hat{ }13 | 11.8 | 100.1 |

### 7-10. Production Example of Comparative Developing Roller L-1

Materials of the type and amount shown in Table 17 below were added to the inside of the reaction vessel and stirred. Next, 2-butanone (MEK) was added so that the total solid ratio is 30 mass %, and then mixed with a sand mill. Subsequently, 2-butanone (MEK) was added to adjust the viscosity of the liquid within the range of 6 to 10 mPa·s to prepare a conductive layer-forming coating liquid F-14. A conductive layer roller G-14 was prepared in the same manner as the conductive layer roller G-1 except that the conductive layer-forming coating liquid F-1 was changed to the conductive layer-forming coating liquid F-14.

TABLE 17

| | Parts |
|---|---|
| Material | by mass |
| Polytetramethylene glycol ether polyol | 25 |
| (Trade name: PT G1000SN, Manufactured by | |
| Hodogaya Chemical Co., Ltd.) | |
| Polycarbonate polyol | 75 |
| (Trade name: T5651, Manufactured by Asahi Kasei | |
| Chemicals Corporation) | |
| Isocyanate | 55.5 |
| (Trade name: Coronate HX, Manufactured by | |
| Tosoh Corporation) | |
| Surface adjusting agent | 0.8 |
| (Trade name: TSF4445, Manufactured by Momentive | |
| Performance Materials, Inc.) | |
| Carbon black | 30 |
| (Trade name: MA8, Manufactured by Mitsubishi | |
| Chemical Corporation) | |
| Coarse particles | 20 |
| (Trade name: ART PEARL C-400T, Manufactured by | |
| Negami Chemical Industrial Co., Ltd.) | |

Next, a comparative developing roller L-1 was obtained in the same manner as the developing roller K-20 except that the conductive layer roller G-1 was changed to G-14. The physical properties of the comparative developing roller L-1 are shown in Table 22-1 and Table 22-2.

### 7-11. Production Example of Comparative Developing Roller L-2

The materials shown in Table 18 below were weighed, MEK was added so that the concentration was 5.0 mass %, and the materials were dissolved well to prepare an impregnation-coating liquid M-1.

TABLE 18

| | Parts |
|---|---|
| Material | by mass |
| Vinyl monomer: vinyl benzoate | 100 |
| Manufactured by Tokyo Chemical Industry Co., Ltd. | |
| Polymerization initiator: tert-butyl-peroxy- | 5 |
| 2-ethylhexyl monocarbonate (Trade name: | |
| PERBUTYL E, Manufactured by NOF CORPORATION) | |

Next, the comparative developing roller L-1 was held at the upper end thereof with the longitudinal direction set to the vertical direction, and immersed (dipped) in the impregnation-coating liquid M-1 to impregnate the conductive layer surface of the comparative developing roller L-1 with the vinyl monomer and the polymerization initiator. The resulting coated matter was air-dried at normal temperature for 30 minutes and then cured by drying in a hot air-circulating drier set at 120° C. for 2 hours to obtain a comparative developing roller L-2. The physical properties of the comparative developing roller L-2 are shown in Table 22-1 and Table 22-2.

The second region (conductive portion) of the comparative developing roller L-2 was analyzed by microscopic IR (trade name: Full Auto Micro FT-IR System: LUMOS, manufactured by Bruker Optics, Inc.) to check that the conductive portion was impregnated with the resin derived from the vinyl monomer.

### 7-12. Production Examples of Comparative Developing Rollers L-3 and L-4

Conductive layer-forming coating liquids F-15 and F-16 were prepared in the same manner as the conductive layer-forming coating liquid F-1 except that the carbon black used in the conductive layer-forming coating liquid F-1 was changed to the materials shown in Table 19 below. Conductive layer rollers G-15 and G-16 and comparative developing rollers L-3 and L-4 were obtained in the same manner as the developing roller K-20 except that the conductive layer-forming coating liquid F-1 was changed to F-15 and F-16, respectively. The physical properties of the comparative developing rollers L-3 and L-4 are shown in Table 22-1 and Table 22-2.

TABLE 19

| Developing | Insulating | | Conductive | Carbon black material | | | |
|---|---|---|---|---|---|---|---|
| roller/ | portion- | | layer- | | Primary | DBP | |
| comparative | forming | Conductive | forming | | particle | absorption | |
| developing | coating | layer roller | coating | | diameter | amount | |
| roller No. | liquid No. | No. | liquid No. | Material name | [nm] | [ml/100 g] | pH |
| K-20 | J-8 | G-1 | F-1 | MA8 | 24 | 51 | 2.5 |
| | | | | (Manufactured by Mitsubishi | | | |
| | | | | Chemical Corporation) | | | |
| L-3 | J-8 | G-15 | F-15 | MA230 | 30 | 113 | 3 |
| | | | | (Manufactured by Mitsubishi | | | |
| | | | | Chemical Corporation) | | | |
| L-4 | J-8 | G-16 | F-16 | MA14 | 40 | 73 | 3 |
| | | | | (Manufactured by Mitsubishi | | | |
| | | | | Chemical Corporation) | | | |

### 7-13. Production Examples of Comparative Developing Rollers L-5 to L-7

Conductive layer-forming coating liquids F-17 to F-19 were prepared in the same manner as the conductive layer-forming coating liquid F-1 except that the additive used in the conductive layer forming coating liquid F-1 was changed to the material and parts by mass shown in Table 20 below. Conductive layer rollers G-17 to G-19 and comparative developing rollers L-5 to L-7 were obtained in the same manner as the developing roller K-20 except that the conductive layer-forming coating liquid F-1 was changed to F-17 to F-19, respectively. The physical properties of the comparative developing rollers L-5 to L-7 are shown in Table 22-1 and Table 22-2.

TABLE 20

| Developing | Insulating | | Conductive | | |
|---|---|---|---|---|---|
| roller/ | portion- | | layer- | | |
| comparative | forming | Conductive | forming | Additive | |
| developing | coating | layer | coating | | Parts |
| roller No. | liquid No. | roller No. | liquid No. | Material | by mass |
| K-20 | J-8 | G-1 | F-1 | E-1 | 7 |
| L-5 | J-8 | G-17 | F-17 | E-1 | 5.25 |
| L-6 | J-8 | G-18 | F-18 | Silane coupling agent (Trade name: | 14 |
| | | | | A-187, Manufactured by Momentive | |
| | | | | Performance Materials, Inc.) | |
| L-7 | J-8 | G-19 | F-19 | Polymer-based dispersing agent (Trade | 24.5 |
| | | | | name: Disper byk-185, Manufactured | |
| | | | | by BYK-Chemie GmbH) | |

### 7-14. Production Example of Comparative Developing Roller L-8

A conductive layer-forming coating liquid F-20 was prepared in the same manner as the conductive layer-forming coating liquid F-1 except that the additive used in the conductive layer forming coating liquid F-1 was changed to E-5 shown in Table 21 below. A conductive layer roller G-20 and a comparative developing roller L-8 were obtained in the same manner as the developing roller K-20 except that the conductive layer-forming coating liquid F-1 was changed to F-20. The physical properties of the comparative developing roller L-8 are shown in Table 22-1 and Table 22-2.

### 7-15. Production Example of Comparative Developing Roller L-9

### Synthesis of Additive E-6

An additive E-6, which is a polyetheramine, was obtained by synthesizing polyoxyethylene polyoxypropylene decyl ether, which was then ketonized by oxidation of a secondary alcohol, followed by reductive amination.

### Synthesis of Polyoxyethylene Polyoxypropylene Decyl Ether

An autoclave equipped with a stirring apparatus, a temperature control apparatus, and an automated charging apparatus was charged with 205.8 g of 1-decanol (manufactured by Tokyo Chemical Industry Co., Ltd.) and 3.0 g of potassium hydroxide, and dehydration was performed at 110° C. and 1.2 kPa for 30 minutes. After completion of dehydration, nitrogen substitution was performed, and after the temperature was raised to 150° C., 858.0 g (15 mol with respect to alcohol) of ethylene oxide was charged. The reaction was performed at 150° C. for 1 hour to obtain an ethylene oxide adduct with an average number of moles added of 15.

After cooling the resulting ethylene oxide adduct to 130° C., 1132.6 g (15 mol with respect to alcohol) of propylene oxide was charged. After the completion of charging, the reaction was performed at 130° C. for 5 hours to obtain a polyoxyethylene polyoxypropylene decyl ether adduct that was a block polymer having an average number of moles of ethylene oxide added of 15 and an average number of moles of propylene oxide added of 15.

The resulting polyoxyethylene polyoxypropylene octyl decyl adduct was cooled to 80° C., and unreacted ethylene oxide and propylene oxide were removed at 2.5 kPa for 30 minutes. Next, an autoclave was charged with 6.0 g of 90% lactic acid, and the content was stirred at 80° C. for 30 minutes, and polyoxyethylene polyoxypropylene decyl ether was obtained by extraction.

### Synthesis of Polyetheramine E-6

A three-necked flask was fitted with a stirrer, and 1688 g of polyoxyethylene polyoxypropylene decyl ether and 460 ml of acetic acid were charged. To this, 600 ml of a 2 mol/l aqueous sodium hypochlorite solution was added dropwise over 1 hour. At this time, the reaction vessel was placed in an ice bath to cool so that the temperature was in the range of 15° C. to 25° C. After the end of the dropwise addition, stirring was continued for 1 hour. To the resulting liquid, dichloromethane was added, and the aqueous layer was then extracted, post-treated, and purified on a column to yield a ketonized compound of a secondary alcohol.

While cooling at 0° C. with an ice bath, 41.4 g of the resulting ketonized compound of a secondary alcohol was added to 250 ml of a methanol-acetic acid mixed solution (volume ratio 10:1), and 2.7 g of 2-picoline-borane was added. The ice bath was removed and the mixture was stirred overnight in an open system at room temperature. After concentration, the reaction mixture was cooled to 0° C., and 360 ml of a 35% aqueous hydrochloric acid solution was then added, and the mixture was stirred at room temperature for 2 hours. An aqueous sodium hydroxide solution was added to make the mixture basic, and the aqueous layer was extracted with dichloromethane, post-treated, and purified on a column to yield polyetheramine E-6. The structure of R61 in E-6 and the values of v and w are shown in Table 21.

A conductive layer-forming coating liquid F-21 was prepared in the same manner as the conductive layer-forming coating liquid F-1 except that the additive used in the conductive layer forming coating liquid F-1 was changed to E-6 shown in Table 21 below. A conductive layer roller G-21 and a comparative developing roller L-9 were obtained in the same manner as the developing roller K-20 except that the conductive layer-forming coating liquid F-1 was changed to F-21. The physical properties of the comparative developing roller L-9 are shown in Table 22-1 and Table 22-2.

### 7-16. Production Example of Comparative Developing Roller L-10

### Synthesis of Additive E-7

An autoclave equipped with a stirring apparatus, a temperature control apparatus, and an automated charging apparatus was charged with 315.2 g of 1-hexadecanol (manufactured by Tokyo Chemical Industry Co., Ltd.) and 3.0 g of potassium hydroxide, and dehydration was performed at 110° C. and 1.2 kPa for 30 minutes. After completion of dehydration, nitrogen substitution was performed, and after the temperature was raised to 150° C., 858.0 g (15 mol with respect to alcohol) of ethylene oxide was charged. The reaction was performed at 150° C. for 1 hour to obtain an ethylene oxide adduct with an average number of moles added of 15.

Then, 90.2 g of the resulting ethylene oxide adduct and 510 ml of a 1 mol/L aqueous sodium hydroxide solution were mixed, then 71.1 g of potassium permanganate was added, and stirred at room temperature for 6 hours. After that, 760 ml of 2-propanol was added and stirred for 1 hour to quench the excess potassium permanganate, and the by-product manganese oxide was filtered. The aqueous layer was extracted with dichloromethane and purified to yield E-7, which is polyoxyethylene methyl ether acetate. The structure of R71 in E-7 and the value of x are shown in Table 21.

A conductive layer-forming coating liquid F-22 was prepared in the same manner as the conductive layer-forming coating liquid F-1 except that the additive used in the conductive layer forming coating liquid F-1 was changed to E-7 shown in Table 21 below. A conductive layer roller G-22 and a comparative developing roller L-10 were obtained in the same manner as the developing roller K-20 except that the conductive layer-forming coating liquid F-1 was changed to F-22. The physical properties of the comparative developing roller L-10 are shown in Table 22-1 and Table 22-2.

TABLE 21

| No. | Material | Structure | | |
|---|---|---|---|---|
| E-5 | Polyoxyethylene polyoxypropylene | Formula (5) | R51 = C₁₆H₃₃ | t = 20, u = 8 |
| | cetyl ether (Trade name: UNISAFE 20P-8, | | | |
| | Manufactured by NOF CORPORATION) | | | |
| E-6 | Polyetheramine | Formula (6) | R61 = C₁₀H₂₁ | v, w = 15 |
| E-7 | Polyoxyethylene hexadecyl ether acetate | Formula (7) | R71 = C₁₆H₃₃ | x = 14 |

TABLE 22-1

| | | | | Physical properties of conductive layer | | | |
|---|---|---|---|---|---|---|---|
| | | | | Physical properties of carbon | | | |
| | | Insulating | | black | | | |
| | | portion- | | Primary | DBP | | Minimum |
| Comparative | Impregnation- | forming | Conductive | particle | absorption | | value of |
| developing | coating | coating | layer roller | diameter | amount | | impedance |
| roller No. | liquid No. | liquid No. | No. | [nm] | [ml/100 g] | pH | [Ω] |
| L-1 | — | J-8 | G-14 | 24 | 51 | 2.5 | 4.0E+05 |
| L-2 | M-1 | J-8 | G-14 | 24 | 51 | 2.5 | 3.9E+05 |
| L-3 | — | J-8 | G-15 | 30 | 113 | 3 | 2.3E+04 |
| L-4 | — | J-8 | G-16 | 40 | 73 | 3 | 1.6E+05 |
| L-5 | — | J-8 | G-17 | 24 | 51 | 2.5 | 4.6E+05 |
| L-6 | — | J-8 | G-18 | 24 | 51 | 2.5 | 2.0E+08 |
| L-7 | — | J-8 | G-19 | 24 | 51 | 2.5 | 4.2E+05 |
| L-8 | — | J-8 | G-20 | 24 | 51 | 2.5 | 1.6E+05 |
| L-9 | — | J-8 | G-21 | 24 | 51 | 2.5 | 1.2E+05 |
| L-10 | — | J-8 | G-22 | 24 | 51 | 2.5 | 8.9E+04 |

| | Physical properties of conductive layer | | | | | | | |
|---|---|---|---|---|---|---|---|---|
| | | | Dispersion state of carbon black | | | | | |
| | | | Dispersion circle-equivalent | | | | | |
| | | | diameter | | | Inter-wall distance | | |
| | Surface | | | Standard | | | Standard | |
| Comparative | potential | | Mean | deviation | | | deviation | |
| developing | V_{\|N\|} − V₁ | T₂ | Rc | σc | | Mean d | σd | |
| roller No. | [V] | [Sec] | [nm] | [nm] | σc/Rc | [nm] | [nm] | σd/d |
| L-1 | 3.7 | 0.6 | 92.9 | 60.7 | 0.653 | 146.8 | 95.6 | 0.651 |
| L-2 | 3.9 | 0.7 | 92.9 | 60.7 | 0.653 | 146.8 | 95.6 | 0.651 |
| L-3 | 2.4 | 0.6 | 88.0 | 56.0 | 0.636 | 130.1 | 79.5 | 0.611 |
| L-4 | 8.7 | 1.9 | 104.0 | 79.7 | 0.766 | 205.8 | 130.7 | 0.635 |
| L-5 | 3.5 | 1.0 | 86.8 | 57.0 | 0.657 | 129.8 | 80.1 | 0.617 |
| L-6 | 462.0 | 6.1 | 57.0 | 34.0 | 0.596 | 112.7 | 63.8 | 0.566 |
| L-7 | 4.6 | 1.2 | 87.8 | 55.5 | 0.632 | 130.7 | 79.5 | 0.608 |
| L-8 | 7.6 | 2.0 | 89.1 | 57.6 | 0.646 | 148.2 | 98.7 | 0.666 |
| L-9 | 6.8 | 1.8 | 92.0 | 61.0 | 0.663 | 145.7 | 97.6 | 0.670 |
| L-10 | 2.5 | 0.8 | 96.1 | 65.0 | 0.676 | 152.3 | 100.2 | 0.658 |

Regarding the impedance measurement of the comparative developing rollers L-1 to L-10, the minimum value of the impedance indicates the minimum value of the impedance value at a frequency of 1.0×10⁰ Hz to 1.0×10¹ Hz.

TABLE 22-2

| | | | | Physical properties of insulating portion | | | |
|---|---|---|---|---|---|---|---|
| | | Insulating | | Proportion of | Volume | | |
| | | portion- | | total area of | resistivity of | | |
| Comparative | Impregnation- | forming | Conductive | insulating | insulating | Surface potential | |
| developing | coating liquid | coating | layer roller | portion | portion | V₁ | T₁ |
| roller No. | No. | liquid No. | No. | [%] | [Ω · cm] | [V] | [Sec] |
| L-1 | — | J-8 | G-14 | 30 | 7.9E+13 | 11.9 | 99.7 |
| L-2 | M-1 | J-8 | G-14 | 30 | 8.3E+13 | 12.2 | 102.3 |
| L-3 | — | J-8 | G-15 | 30 | 7.9E+13 | 12.0 | 97.7 |
| L-4 | — | J-8 | G-16 | 29 | 7.9E+13 | 11.9 | 101.8 |
| L-5 | — | J-8 | G-17 | 30 | 7.9E+13 | 11.8 | 98.4 |
| L-6 | — | J-8 | G-18 | 30 | 7.9E+13 | 12.2 | 96.9 |
| L-7 | — | J-8 | G-19 | 29 | 7.9E+13 | 12.1 | 101.1 |
| L-8 | — | J-8 | G-20 | 30 | 7.9E+13 | 12.3 | 103.7 |
| L-9 | — | J-8 | G-21 | 30 | 7.9E+13 | 11.8 | 101.5 |
| L-10 | — | J-8 | G-22 | 29 | 7.9E+13 | 12.0 | 99.0 |

### 8. EXAMPLES

### 8-1. Example 1

Hereinafter, the evaluation method and the evaluation criteria of the present disclosure will be described.

As the electrophotographic image forming apparatus, a remodeling machine of a commercially available laser printer, LBP-7600C (manufactured by CANON INC.) was used. The configuration of the remodeling machine is shown in FIG. 10. The machine was modified so as to be connected to an external high-voltage power source 20C in addition to power sources 14C and 15C and to provide an arbitrary potential difference between the developing blade and the developing roller, and the number of output sheets per unit time was set to 50 sheets/min for A4 size paper sheets for evaluation in high-speed processes.

As the process cartridge, a commercially available toner cartridge 318 (cyan) (manufactured by CANON INC.) was used, and the developing roller was replaced with the developing roller K-1 of the present disclosure. Furthermore, the gear of the toner supply roller was removed from the process cartridge to reduce the drive torque. By removing the gear, the toner supply roller is driven to rotate with respect to the developing roller to reduce the drive torque, while the amount of the toner supplied to the developing roller and the toner charging performance after printing a high density image are easily reduced.

Yellow, magenta, and black cartridges were inserted into the yellow, magenta, and black stations, respectively, with the product toner removed and the remaining toner detection mechanism disabled, and the evaluation was performed.

Evaluation of Toner Transportability after Long-Term Standing in High-Temperature and High-Humidity Environment

The process cartridge equipped with the developing roller K-1 was allowed to stand for 30 days in an environment at a temperature of 40° C. and a relative humidity of 95%. This is a condition that the humidity difference between the outside and inside of the process cartridge is sufficiently eliminated and the entire developing roller absorbs moisture uniformly.

Next, the process cartridge taken out from the environment was quickly moved to an environment at a temperature of 30° C. and a relative humidity of 80%, and was allowed to stand for 24 hours. At the same time, a remodeling machine of the laser printer and an evaluation paper sheet (GFC81 (manufactured by CANON INC.) A4: 81.4 g/m²) were allowed to stand in the same environment for 24 hours.

The process cartridge allowed to stand was loaded into the laser printer remodeling machine, the potential difference between the developing blade and the developing roller was set to −300 V, and one sheet of all-black image was output. The density of the resulting all-black image was then measured using a spectrodensitometer (trade name: X-Rite 504, manufactured by SDG Co., Ltd.). A value obtained by subtracting the arithmetic mean of the image densities at 5 points within 20.0 mm from the rear end in the image transporting direction from the arithmetic mean of the image densities at 5 points within 20.0 mm from the tip end in the image transporting direction was obtained as an image density difference.

Since the gear of the toner supply roller is removed in order to reduce the drive torque of the process cartridge, charges leak from the insulating portion of the developing roller to the conductive portion, and when the toner transporting force is insufficient, the image density decreases toward the rear end of the image. Note that the width of 20.0 mm in the image transporting direction is within one circumference of the developing roller.

The results obtained were evaluated on the basis of the following criteria. The evaluation results are shown in Table 23 below.
Rank A: The image density difference is less than 0.10.
Rank B: The image density difference is 0.10 or more and less than 0.20.
Rank C: The image density difference is 0.20 or more and less than 0.30.
Rank D: The image density difference is 0.30 or more.
   Evaluation of Fogging Immediately after High-Density Image Printing in High-Temperature and High-Humidity Environment

After the evaluation of the toner transportability in the high-temperature and high-humidity environment, one sheet of image in which 150.0 mm from the tip end in the image transporting direction is all-black and the rest is all-white was output in the same environment.

The reflection density R1 of the evaluation paper sheet before image formation and the reflection density R2 of the all-white portion within 20.0 mm from the rear end of the all-black portion in the image transporting direction (that is, a position of 150.0 mm to 170.0 mm from the tip end in the image transporting direction) were measured using a reflection density meter (trade name: TC-6DS/A manufactured by Tokyo Denshoku Gijutsu Center Ltd.), and the increase in reflection density (R2−R1) was defined as the fogging value. As the reflection density R1 of the evaluation paper sheet before image formation, an arithmetic mean obtained by performing measurement at five points from the entire evaluation paper sheet was adopted, and as the reflection density R2 of the all-white portion, a maximum value obtained by performing measurement at five points from the above region was adopted. The smaller the fogging value, the better.

The results obtained were evaluated on the basis of the following criteria: The evaluation results are shown in Table 23 below.
Rank A: The fogging value is less than 1.0%
Rank B: The fogging value is 1.0% or more and less than 2.0%
Rank C: The fogging value is 2.0% or more and less than 3.0%
Rank D: The fogging value is 3.0% or more

Evaluation of Toner Transportability after Continuous Sheet Feeding in Low-Temperature and Low-Humidity Environment

Similarly to the process cartridge, the gear of the toner supply roller was removed to prepare a process cartridge equipped with the developing roller K-1.

Next, the process cartridge, a remodeling machine of the laser printer, and an evaluation paper sheet (GFC81 (manufactured by CANON INC.) A4: 81.4 g/m²) were allowed to stand in an environment at a temperature of 15° C. and a relative humidity of 10% for 24 hours.

The process cartridge allowed to stand was loaded into the laser printer remodeling machine, the potential difference between the developing blade and the developing roller was set to −300 V, and 1000 sheets of images with a print percentage of 2% and one sheet of all-black image were continuously output in this order.

The density of the resulting all-black image was measured using a spectrodensitometer (trade name: X-Rite 504, manufactured by SDG Co., Ltd.). A value obtained by subtracting the arithmetic mean of the image densities at 5 points within 20.0 mm from the rear end in the image transporting direction from the arithmetic mean of the image densities at 5 points within 20.0 mm from the tip end in the image transporting direction was obtained as an image density difference.

When the gear of the toner supply roller is removed and the drive torque of the process cartridge is reduced, if the toner transporting force of the developing roller is insufficient, the image density decreases toward the rear end of the image. Since the gear of the toner supply roller is removed in order to reduce the drive torque of the process cartridge, if the developing roller conductive portion is charged up by continuous paper feeding and the potential difference between the developing roller conductive portion and the insulating portion decreases, the toner transporting force is insufficient and the image density decreases toward the rear end of the image.

The results obtained were evaluated on the basis of the following criteria: The evaluation results are shown in Table 23 below.
Rank A: The image density difference is less than 0.10
Rank B: The image density difference is 0.10 or more and less than 0.20
Rank C: The image density difference is 0.20 or more and less than 0.30
Rank D: The image density difference is 0.30 or more

### 8-2. Examples 2 to 20 and Comparative Examples 1 to 10

Evaluation was performed in the same manner as in Example 1 except that developing rollers K-2 to K-20, and comparative developing rollers L1 to L10 were used. The evaluation results are shown in Table 23 below.

TABLE 23

| | | | After long-term standing in high- | | In low-temperature |
|---|---|---|---|---|---|
| | | | temperature and high-humidity | | and low-humidity |
| | | | environment | | environment |
| | | | | Fogging immediately | Toner transportability |
| Example/Comparative | | Developing | Toner | after printing high- | after continuous |
| Example | No. | roller No. | transportability | density image | sheet feeding |
| Example | 1 | K-1 | A | A | A |
| Example | 2 | K-2 | A | A | B |
| Example | 3 | K-3 | A | A | B |
| Example | 4 | K-4 | B | A | A |
| Example | 5 | K-5 | B | A | A |
| Example | 6 | K-6 | B | A | A |
| Example | 7 | K-7 | B | A | A |
| Example | 8 | K-8 | B | A | A |
| Example | 9 | K-9 | A | A | A |
| Example | 10 | K-10 | A | A | A |
| Example | 11 | K-11 | A | A | A |
| Example | 12 | K-12 | A | A | A |
| Example | 13 | K-13 | B | A | A |
| Example | 14 | K-14 | A | A | A |
| Example | 15 | K-15 | A | A | A |
| Example | 16 | K-16 | A | A | A |
| Example | 17 | K-17 | A | B | A |
| Example | 18 | K-18 | A | A | A |
| Example | 19 | K-19 | A | A | A |
| Example | 20 | K-20 | C | C | A |
| Comparative Example | 1 | L-1 | D | D | A |
| Comparative Example | 2 | L-2 | D | D | A |
| Comparative Example | 3 | L-3 | D | D | A |
| Comparative Example | 4 | L-4 | D | D | A |
| Comparative Example | 5 | L-5 | D | D | A |
| Comparative Example | 6 | L-6 | B | B | D |
| Comparative Example | 7 | L-7 | D | D | A |
| Comparative Example | 8 | L-8 | D | D | A |
| Comparative Example | 9 | L-9 | D | D | A |
| Comparative Example | 10 | L-10 | D | D | A |

According to the above results, the developing roller of the present disclosure has a high process speed, and can prevent toner transport failure even when the developing roller is used in various environments for a long period of time with a reduced drive torque.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145570, filed Aug. 27, 2024, which is hereby incorporated by reference herein in its entirety.

What is claimed is:

1. A developing roller, comprising:
a substrate having a conductive outer surface; and
a conductive layer on the outer surface of the substrate, wherein
an outer surface of the developing roller is formed of at least a first region and a second region having higher conductivity than the first region,
the first region and the second region are placed adjacent to each other,
the first region is placed on an outer surface of the conductive layer,
when a metal film is directly provided on the outer surface of the developing roller, and while changing a frequency between 1.0×10⁻¹ to 1.0×10⁵ Hz, an AC voltage with an amplitude of 50 V is applied between the outer surface of the substrate and the metal film while a DC voltage of 50 V is applied in an environment at a temperature of 23° C. and a relative humidity of 50%, an impedance at a frequency of 1.0×10⁰ to 1.0×10¹ Hz is 1.0×10⁶Ω or more,
in a case where when a corona discharger having a grid portion with a width of 3.0 mm is placed in an environment at a temperature of 23° C. and a relative humidity of 50% such that a distance between the grid portion and the outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured,
the potential at t=0.06 [sec] is denoted by V_{INI} [V],
a change in the potential at 30.00≤t≤100.00 is fitted to a formula (X′) below by a least squares method to obtain V_{0,1} [V] and τ₁ [sec], when a value of a potential V₁(t) at the time of substituting t=0.06 [sec] into the formula (X′) is denoted by V₁ [V], V_{INI}−V₁ is less than 20.0 V:
$${V}_{1} ( t ) = {V}_{0 , 1} exp ( - t / {τ}_{1} ) . \qquad ( {X}^{′} )$$

2. The developing roller according to claim 1, wherein τ₁ is 60.0 seconds or more.

3. The developing roller according to claim 1, wherein V₁ is 5.0 V or more.

4. The developing roller of claim 1, wherein in a case where when the corona discharger having a grid portion with a width of 3.0 mm is placed in an environment at a temperature of 23° C. and a relative humidity of 50% such that a distance between the grid portion and the outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured,
a change in the potential at 0.06≤t≤100.00 is fitted to a formula (Y) below by a least squares method to obtain V_{0,2} [V] and τ₂ [sec],
τ₂ is 6.0 seconds or less:
$$V ( t ) = {V}_{1} ( t ) + {V}_{2} ( t ) \qquad ( Y )$$
$$in the formula ( Y ) , {V}_{2} ( t ) = {V}_{0 , 2} exp ( - t / {τ}_{2} ) . \qquad ( Z )$$

5. The developing roller according to claim 1, wherein V_{INI}−V₁ is 10.0 V or less.

6. The developing roller according to claim 1, wherein when a square observation region with a side length of 300 μm is placed on the outer surface of the developing roller such that the axial direction of the developing roller and one side of the observation region are parallel to each other, a proportion of a total area of the first region to an area of the square observation region is 10 to 60 area %.

7. The developing roller according to claim 1, wherein the conductive layer comprises polyurethane.

8. The developing roller according to claim 1, wherein the conductive layer comprises polyurethane having a polycarbonate structure.

9. The developing roller according to claim 8, wherein the polyurethane satisfies at least two of the following (A), (B), and (C):
(A) the polyurethane has a structure represented by a structural formula (1) below in a molecule;
(B) the polyurethane has one or both structures of a structure represented by a structural formula (2) below and a structure represented by a structural formula (3) below in a molecule; and
(C) the polyurethane has a structure represented by a structural formula (4) below in a molecule: 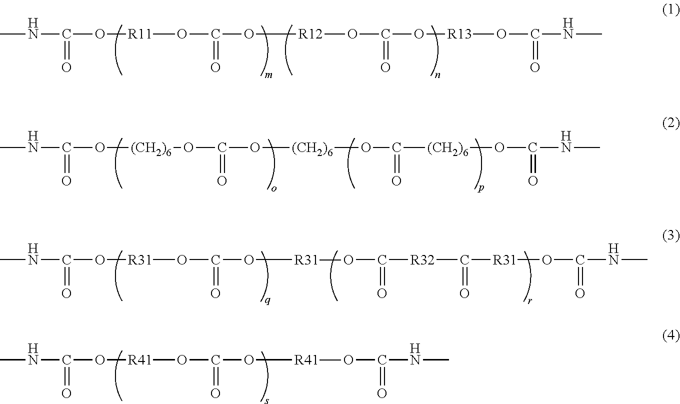
in the structural formula (1), R11, R12, and R13 represent a divalent hydrocarbon group having 3 to 9 carbon atoms, provided that R11 and R12 are different from each other, and R13 is the same as at least one selected from a group consisting of R11 and R12, m and n are average numbers of moles added, and each independently represent a number of 1.0 or more,
in the structural formula (2), o and p are average numbers of moles added, and each independently represent a number of 1.0 or more,
in the structural formula (3), R31 and R32 each independently represent a divalent hydrocarbon group having 3 to 8 carbon atoms, q and r are average numbers of moles added, and each independently represent a number of 1.0 or more,
in the structural formula (4), R41 represents a divalent hydrocarbon group having 6 to 9 carbon atoms, and s is an average number of moles added, and represents a number of 1.0 or more.

10. The developing roller according to claim 1, wherein the conductive layer comprises a carbon black.

11. The developing roller according to claim 7, wherein the conductive layer contains at least one selected from a group consisting of a compound represented by a structural formula (5) below, a compound represented by a structural formula (6) below, and a compound represented by a structural formula (7) below: 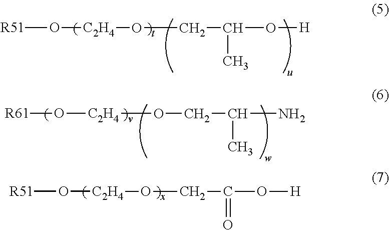
in the structural formula (5), R51 represents a monovalent hydrocarbon group having 1 to 12 carbon atoms, and t and u are average numbers of moles added, and each independently represent a number of 1.0 or more,
in the structural formula (6), R61 represents a monovalent hydrocarbon group having 1 to 8 carbon atoms, and v and w are average numbers of moles added, and each independently represent a number of 1.0 or more,
in the structural formula (7), R71 represents a monovalent hydrocarbon group having 1 to 12 carbon atoms, and x is an average number of moles added, and represents a number of 1.0 or more.

12. The developing roller according to claim 10, wherein an arithmetic mean Rc of a circle-equivalent diameter of the carbon black in the conductive layer is 60.0 nm or less, and
when a standard deviation of the circle-equivalent diameter of the carbon black is denoted by σc, σc/Rc is 0.000 to 0.650.

13. The developing roller according to claim 10, wherein an arithmetic mean d of an inter-wall distance of the carbon black in the conductive layer is 80.0 to 150.0 nm, and
when a standard deviation of the inter-wall distance is denoted by σd, σd/d is 0.000 to 0.600.

14. The developing roller according to claim 10, wherein a number average diameter of primary particles of the carbon black in the conductive layer is 30 nm or less.

15. The developing roller according to claim 10, wherein a DBP absorption amount of the carbon black in the conductive layer is 90 ml/100 g or less, and
the carbon black has a pH of 4.0 or less.

16. The developing roller according to claim 1, wherein the first region comprises at least one type of polycarbonate, and
the at least one type of polycarbonate has a structure represented by a structural formula (8) below:
in the structural formula (8), R81 to R88 are each independently a hydrogen atom, an alkyl group having 1 to 9 carbon atoms, or an aryl group having 6 to 10 carbon atoms,
R89 and R90 each independently represent a hydrogen atom, an alkyl group having 1 to 9 carbon atoms, or an aryl group having 6 to 10 carbon atoms, or
R89 and R90 are a group of atoms necessary for R89 and R90 to be bonded to each other to form an alicyclic structure having 6 to 12 carbon atoms,
provided that the structural formula (8) satisfies at least one condition selected from a group consisting of Condition 1 and Condition 2 below:
Condition 1
at least one selected from a group consisting of R81 to R88 is the alkyl group having 1 to 9 carbon atoms, or the aryl group having 6 to 10 carbon atoms, and
Condition 2
at least one selected from a group consisting of R89 and R90 is a linear or branched alkyl group having 2 or more carbon atoms or the aryl group having 6 to 10 carbon atoms.

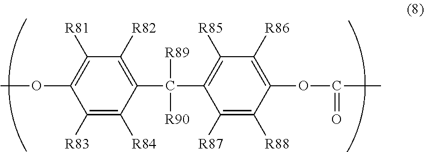

17. The developing roller according to claim 16, wherein the at least one type of polycarbonate has a structure represented by a structural formula (9) below:

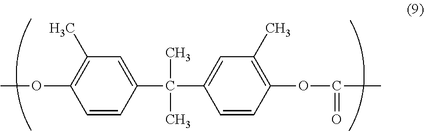

18. The developing roller according to claim 16, wherein the at least one type of polycarbonate has at least one structure selected from a group consisting of a structure represented by a structural formula (10) below and a structure represented by a structural formula (11) below:

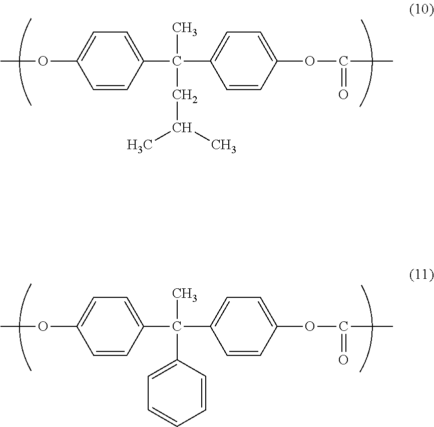

19. A process cartridge configured to be attachable to and detachable from a main body of an electrophotographic image forming apparatus, the process cartridge comprising a developing unit, wherein the developing unit comprises the developing roller according to claim 1.

20. An electrophotographic image forming apparatus comprising a developing unit, wherein the developing unit comprises the developing roller according to claim 1.
